(19) United States
(12) Patent Application Publication
(10) Pub. No.: US 2024/0281808 A1
(43) Pub. Date: Aug. 22, 2024

(54) REAL-TIME PRE-APPROVAL OF DATA EXCHANGES USING TRAINED ARTIFICIAL INTELLIGENCE PROCESSES

(71) Applicant: The Toronto-Dominion Bank, Toronto (CA)

(72) Inventors: Noël VOUITSIS, Markham (CA); Jesse Cole CRESSWELL, Toronto (CA); Xiaochen ZHANG, Toronto (CA); Yi SUI, Newmarket (CA); Peter STARSZYK, Waterloo (CA); Devinder KUMAR, Toronto (CA); Darren Andrew PEPPER, Toronto (CA); Jean-Christophe BOUËTTÉ, Montreal (CA); Omar SABBAGH, Edmonton (CA)

(21) Appl. No.: 18/138,413

(22) Filed: Apr. 24, 2023

Related U.S. Application Data
(60) Provisional application No. 63/447,590, filed on Feb. 22, 2023.

(51) Int. Cl. G06Q 20/40

(52) U.S. Cl. CPC G06Q 20/401

(57) ABSTRACT

The disclosed embodiments include computer-implemented apparatuses and processes that facilitate a real-time pre-approval of data exchanges using trained artificial intelligence processes. For example, an apparatus may receive, from a device, application data characterizing an application for an exchange of data involving one or more applicants, and may generate an input dataset based on at least a portion of the application data and on interaction data characterizing the one or more applicants. Further, and based on an application of a trained artificial intelligence process to the input dataset, the apparatus may generate, in real-time, elements of output data indicative of a predicted pre-approval of the application for the data exchange involving the one or more applicants, and may transmit the elements of output data to the device for presentation within a digital interface.

### CROSS-REFERENCE TO RELATED APPLICATION

This application claims the benefit of priority under 35 U.S.C. § 119(e) to prior U.S. Application No. 63/447,590, filed Feb. 22, 2023, the disclosure of which is incorporated by reference herein to its entirety.

### TECHNICAL FIELD

The disclosed embodiments generally relate to computer-implemented systems and processes that facilitate a real-time pre-approval of data exchanges using trained artificial intelligence processes.

### BACKGROUND

Today, financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services, and are based on information provisioned during completion of a product- or service-specific application process by the customers. A scope of the product- or service-specific application process, and an amount of preparation associated with an initiation and completion of the product- or service-specific application process, may differ substantially across the various types of financial products and services offered to the customers, and available for provisioning, by the financial institutions.

### SUMMARY

In some examples, an apparatus includes a memory storing instructions, a communications interface, and at least one processor coupled to the memory and the communications interface. The at least one processor is configured to execute the instructions to receive application data from a device via the communications interface. The application data characterizes an application for an exchange of data involving one or more applicants. The at least one processor is further configured to execute the instructions to generate an input dataset based on at least a portion of the application data and on interaction data characterizing the one or more applicants, and based on an application of a trained artificial intelligence process to the input dataset, to generate, in real-time, elements of output data indicative of a predicted pre-approval of the application for the data exchange involving the one or more applicants. The at least one processor is further configured to execute the instructions to transmit the elements of output data to the device via the communications interface, and the device is configured to process the elements of output data and present a graphical representation of the predicted pre-approval within a digital interface.

In other examples, a computer-implemented method includes receiving application data from a device using at least one processor. The application data characterizes an application for an exchange of data involving one or more applicants. The computer-implemented method also includes, using the at least one processor, generating an input dataset based on at least a portion of the application data and on interaction data characterizing the one or more applicants, and based on an application of a trained artificial intelligence process to the input dataset, generating, in real-time, elements of output data indicative of a predicted pre-approval of the application for the data exchange involving the one or more applicants. The computer-implemented method also includes transmitting the elements of output data to the device using the at least one processor, and the device is configured to process the elements of output data and present a graphical representation of the predicted pre-approval within a digital interface.

Further, in some examples, a tangible, non-transitory computer-readable medium may store instructions that, when executed by at least one processor, cause the at least one processor to perform a method that includes receiving application data from a device using at least one processor. The application data characterizes an application for an exchange of data involving one or more applicants. The method also includes generating an input dataset based on at least a portion of the application data and on interaction data characterizing the one or more applicants, and based on an application of a trained artificial intelligence process to the input dataset, generating, in real-time, elements of output data indicative of a predicted pre-approval of the application for the data exchange involving the one or more applicants. The method also includes transmitting the elements of output data to the device, and the device is configured to process the elements of output data and present a graphical representation of the predicted pre-approval within a digital interface.

### BRIEF DESCRIPTION OF THE DRAWINGS

FIGS. 1 and 2A are block diagrams illustrating portions of an exemplary computing environment, in accordance with some exemplary embodiments.

FIG. 2B is a diagram of an exemplary timeline for adaptively training a machine-learning or artificial intelligence process, in accordance with some exemplary embodiments.

FIGS. 2C and 3 are block diagrams illustrating additional portions of the exemplary computing environment, in accordance with some exemplary embodiments.

FIG. 4 is a flowchart of an exemplary process for adaptively training a machine learning or artificial intelligence process, in accordance with some exemplary embodiments.

FIG. 5 is a flowchart of an exemplary process for predicting an expected final decision on a pre-approval of an application for a data exchange using trained machine learning or artificial intelligence processes, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of customer profile data identifying the customer and characterizing the customer's relationship with the financial institution, elements of account data identifying and characterizing one or more financial products issued to the customer by the financial institution, elements of transaction data identifying and characterizing one or more transactions involving these issued financial products, or elements of reporting data, such as credit-bureau data associated with the customer. The elements of customer profile data, account data, transaction data, and reporting data may establish collectively a time-evolving risk profile for the customer.

By way of example, the particular financial product may include a real estate secured lending (RESL) product, such as, but not limited to, one or more home mortgage products or one or more home-equity line-of-credit (HELOC) products, and in some instances, an underwriting process associated with an approval of an application by a single applicant, or multiple applicants, for a home mortgage, a HELOC, or another RESL product may rely on the time-evolving risk profile established and maintained by the financial institution for the single applicant, or for each of the multiple applicants. Further, prior to completing the often lengthy underwriting process associated with a final approval of a home mortgage, a HELOC, or another RESL product, and with a subsequent provisioning of that home mortgage, HELOC, or other RESL product to the corresponding applicant or applicants by the financial institution, many applicants for elect to request a “pre-approval” of a corresponding application for a home mortgage, a HELOC, or another RESL product from the financial institution, and may rely on the financial institution's pre-approval of the application to initiate a purchase of real estate subject to a completion of the underwriting processes associated with the pre-approved application within a specified time period.

Today, many financial institutions relay on existing manual underwriting processes to determine a decision on a pre-approval of an application for a home mortgage, a HELOC, or another RESL product by a single applicant, or by multiple applicants. For example, the one, or more, applicants may submit an application for a particular home mortgage, HELOC, another RESL product to a financial institution along with information, in physical or digital form, that documents not only a current financial position of each of the one or more applicants (e.g., current income, current amount of assets and liabilities, etc.), but also a time-evolving character of this financial position across a prior temporal interval (e.g., income history, temporal evolution of assets or liabilities, etc.). An underwriter or other representative of the financial institution may review manually the submitted application and supporting information, either alone or in conjunction with other information characterizing the applicants and their interactions with the financial institution (and with other financial institutions), and may issue a decision on the pre-approval of the application to each of the one or more applicants.

In many instances, however, these manual underwriting processes may be associated with delays of days, or even weeks, between a submission of a request to pre-approve an application for a particular home mortgage, HELOC, or other RESL product and the provisioning of a decision on the pre-approval by the underwriter. Further, while certain decisions issued by the underwriters represent “final” decisions to pre-approve, or alternatively, decline an application for a particular home mortgage, HELOC, or other RESL product, many other decisions represent “initial” or “intermediate” decisions that prompt the corresponding applicant, or applicants, to submit additional documentation or information that remedies one or more deficiencies in the prior application identified by the underwriter. As such, these manual underwriting processes often facilitate an evolving, iterative process that bases a final pre-approval decision on a temporal evolution of successive submissions of initial, and intermediate, application and applicant documentation across days, weeks, or even months. The often significant temporal delay associated with the pre-approval of applications for home mortgages, HELOCs, or other RESL products using existing, manual underwriting processes often renders irrelevant an eventual final decision pre-approving an application, especially in a fast-moving marketplace.

Additionally, these manual underwriting processes are often incapable of leveraging the corpus of customer profile, account, transaction, or reporting data characterizing not only an applicant for a home mortgage, HELOC, or other RESL product, but also characterizing other customers of the financial institution having demographic or financial characteristics similar to those of the applicant. Further, although certain adaptive techniques might leverage the corpus of customer profile, account, transaction, or reporting data maintained by the financial institution, these adaptive techniques generally leverage existing batch processing techniques to generate elements of predictive output associated with hundreds, if not thousands, of discrete customers of the financial institution in accordance with a predetermined daily, weekly, or monthly schedule, and not in real-time and contemporaneously with a single, discrete request for pre-approval of an application for a home mortgage, HELOC, or other RESL product.

In some examples, described herein, a machine-learning or artificial-intelligence process may be adaptively trained to predict an expected, final decision on a pre-approval of an application for a RESL product (e.g., an application for a home mortgage, HELOC, or other RESL product, etc.) in real-time and on-demand upon receipt from a corresponding digital channel, such as, but not limited to, an application program executed by a device operable by an applicant (e.g., a mobile application, a web browser, etc.) or an application program executed by a device operable by a representative of the financial institution. As described herein, the machine-learning or artificial-intelligence process may include an ensemble or decision-tree process, such as a gradient-boosted decision-tree process (e.g., an XGBoost process, etc.), and certain of the exemplary training processes described herein may generate, and utilize, training and validation datasets associated with a first prior temporal interval (e.g., an in-time training and validation interval), and using testing datasets associated with a second, and distinct, prior temporal interval (e.g., an out-of-time “testing” interval). Further, and based on an application of the trained, gradient-boosted decision-tree process to an input dataset characterizing the application, each of the one or more applicants, and the RESL product, certain of the exemplary processes may generate an element of output data indicative of the expected, final decision on pre-approval of the application (e.g., a pre-approval of the application or a denial of the application), which may be provisioned to a device via the corresponding digital channel.

One or more of these exemplary processes, which adaptively train and validate a gradient-boosted, decision-tree process using applicant- and application-specific datasets associated with respective training, validation, and testing intervals, and which apply the trained and validated gradient-boosted, decision-tree process to an input dataset associated with a received application for a home mortgage, HELOC, or other RESL product, may enable the one or more computing systems of the financial institution to predict an expected final decision on a pre-approval of the application and to provision that expected final decision to a device that requested the pre-approval of the application, in real-time and contemporaneously with both a generation of a corresponding request for pre-approval by the device and a receipt of the corresponding request by the one or more computing systems of the financial institution. These exemplary processes may, for example, be implemented in addition to, or as alternative to, existing processes adaptive processes that rely on batch-based processing of aggregated pre-approval requests on a daily, monthly, or weekly basis, and existing manual underwriting processes.

### A. Exemplary Processes for Adaptively Training Gradient-Boosted, Decision-Tree Processes in a Distributed Computing Environment

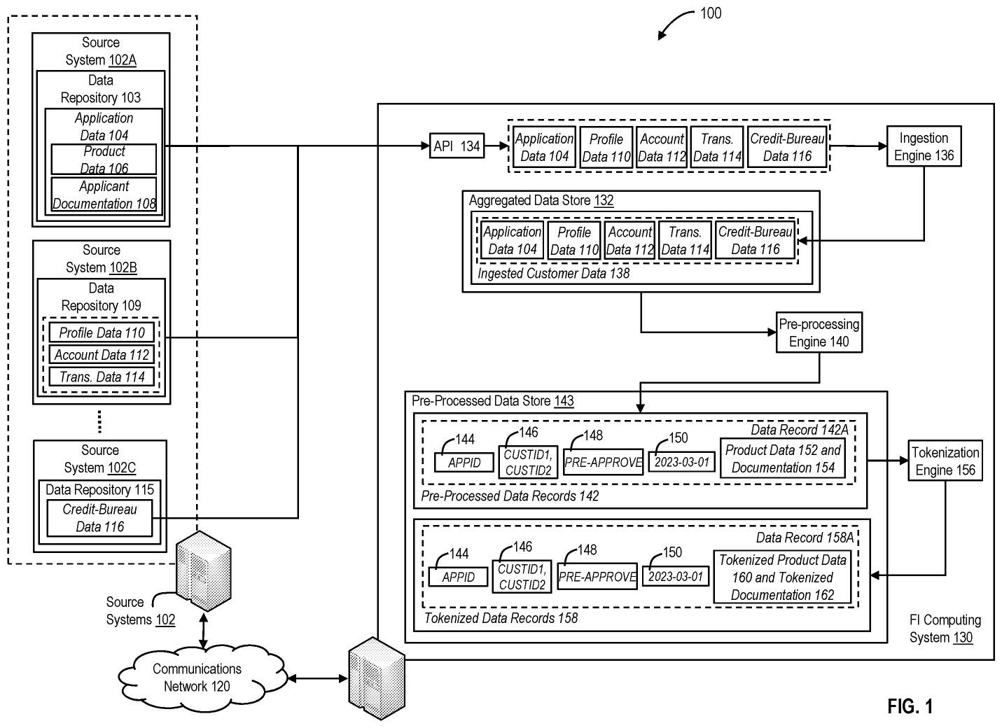

FIG. 1 illustrates components of an exemplary computing environment 100, in accordance with some exemplary embodiments. For example, as illustrated in FIG. 1, environment 100 may include one or more source systems 102, such as, but not limited to, source systems 102A, 102B, and 102C, and a computing system associated with, or operated by, a financial institution, such as financial institution (FI) computing system 130. In some instances, each of source systems 102 (including source systems 102A, 102B, and 102C) and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including source systems 102A, 102B, and 102C) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including source systems 102A, 102B, and 102C) and FI computing system 130 may also include a communications interface, such as one or more wireless transceivers, coupled to the one or more processors for accommodating wired or wireless internet communication with other computing systems and devices operating within environment 100.

Further, in some instances, source systems 102 (including source systems 102A, 102B, and 102C) and FI computing system 130 may each be incorporated into a respective, discrete computing system. In additional, or alternate, instances, one or more of source systems 102 (including source systems 102A, 10B, and 102C) and FI computing system 130 may correspond to a distributed computing system having a plurality of interconnected, computing components distributed across an appropriate computing network, such as communications network 120 of FIG. 1. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™ Amazon Web Services™, Google Cloud™, or another third-party provider.

In some examples, FI computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, to ingest elements of data associated with the customers of the financial institution and with applications for real-estate secured lending (RESL) products (e.g., the home mortgages or the home-equity lines-of-credit (HELOCs) described herein), to preprocess the ingested data elements by filtering, aggregating, or down-sampling certain portions of the ingested data elements, and to store the preprocessed data elements within an accessible data repository (e.g., within a portion of a distributed file system, such as a Hadoop™ distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using datasets extracted from temporally distinct subsets of the preprocessed data elements, but also apply the adaptively trained machine learning or artificial intelligence process to an application-specific input dataset and generate elements of output data indicative of an expected, final decision on a pre-approval of an application for a home mortgage, HELOC, or other RESL product in real-time and on-demand upon receipt from a corresponding digital channel. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1, each of source systems 102 may maintain, within corresponding tangible, non-transitory memories, a data repository that includes confidential data identifying and characterizing customers of the financial institution, interactions between these customers and the financial institution (or other financial institutions) and prior applications for home mortgages, HELOCs, and other RESL products during one or more temporal intervals. For example, source system 102A may be associated with, or operated by, the financial institution, and may maintain, within the corresponding one or more tangible, non-transitory memories, a data repository 103 maintaining elements of application data 104 that identify or characterize applications for home mortgages, HELOCs, and other RESL products initiated by, or involving, one or more corresponding applicants during one or more temporal intervals. As described herein, source system 102A may correspond to a distributed computing system having a plurality of interconnected, computing components distributed across an appropriate computing network, such as communications network 120 of FIG. 1, and source system 102A may maintain source data repository 103 within a portion of a distributed file system, such as an HDFS.

Each of the applications may be associated with a corresponding of the home mortgages, HELOCs, or other RESL products described herein, and further, corresponding ones of the applications may be associated with, and may involve, a single applicant or alternatively, multiple applicants (e.g., “joint” applicants for the corresponding one of the applications for the home mortgages, HELOCs, or other RESL products). For example, the single applicant, or one or more of the multiple applicants, may represent a current customer of the financial institution or alternatively, may represent a prospective customer of the financial institution. Further, in some examples, each of the applications for the home mortgages, HELOCs, or other RESL products may be associated with a corresponding, final decision on pre-approval (e.g., a positive or negative decision) rendered by a corresponding underwriter associated with the financial institution on a corresponding decision date.

In some instances, an application for a corresponding home mortgage, HELOC, or other real-estate secured lending product may associated with, and supported by, a single initial submission of documentation characterizing each of the one or more applicants, assets or liabilities of each of the one or more applicants, and interactions of each of the one or more applicant with the financial institution or with other financial institutions, and the underwriter may issue the final decision that pre-approves (e.g., a positive decision) or that declines to pre-approve (e.g., a negative decision) the application based on the initial submission of documentation, either alone or in conjunction with other information characterizing the one or more applicants and available to the financial institution. The disclosed examples are, however, not limited to applications supported by single, initial submissions of documentation, and in other instances, an application for a corresponding home mortgage, HELOC, or other RESL product may by supported by an initial submission of documentation, and by one or more intermediate submissions of documentation during a temporal interval prior to a final submission of documentation and a final decision on the application by the underwriter. The initial submission of documentation, and each of the intermediate submissions of documentation, may be associated with a corresponding “intermediate” decision on pre-approval by the underwriter, and a transition from the initial submission through the one or more intermediate submissions to the final submission during the temporal interval may reflect a temporal evolution in a financial position of the single applicant, or a subset of the one or more applicants (e.g., changes in an applicant-specific amount of outstanding liabilities, or an applicant-specific income, during the temporal interval).

Referring back to FIG. 1, the elements of application data 104 may include, for each of the applications for the home mortgages, HELOCs, and other RESL products, a corresponding alphanumeric application identifier, decision data characterizing a final decision on a pre-approval of the corresponding application, and temporal data identifying a time or date of the final decision, e.g., by an underwriter. Further, and for each of the applications for the home mortgages, HELOCs, and other RESL products, application data 104 may also maintain corresponding elements of product data 106, which identify and characterize the home mortgage, HELOC, or other RESL product associated with the corresponding application, and elements of applicant documentation 108, which include all, or a portion of, the final submission of documentation supporting the final decision on the pre-approval of the corresponding application.

By way of example, for the corresponding application, the elements of product data 106 may include, but are not limited to, a unique identifier of the corresponding home mortgage, HELOC, or other RESL product (e.g., a product name, a unique, alphanumeric identifier assigned to the RESL product by FI computing system 130, etc.) and a value of one or more parameters of the corresponding home mortgage, HELOC, or other RESL product, such as a loan amount, a loan term, or information characterizing a fixed or variable interest rate. Further, and for the corresponding application, the elements of applicant documentation 108 may include, but are not limited to, a unique identifier of each of the one or more applicants (e.g., an applicant name, an alphanumeric applicant identifier assigned by FI computing system 130, etc.) and information characterizing a parcel of real estate that servers as collateral for the corresponding home mortgage, HELOC, or other RESL product, such as an address, a digital copy of a deed or conveyance, a current assessment of the parcel by a governmental entity, or one or more digital images of the parcel. Further, and for the corresponding application, the elements of applicant documentation 108 may also include, but are not limited to, information characterizing a current residence and employment of the one or more applicants, information characterizing a current and temporal evolution of an income of the one or more applicants, information identifying a current value in, and a temporal evolution of, assets and liabilities held by each of the one or more applicants, information identifying a current value of, and a temporal evolution of, a credit score of the one or more applicants and/or information characterizing an employment or tax history of the one or more applicants.

The disclosed embodiments are, however, not limited to these exemplary elements of product data and applicant documentation, and in other instances, product data 106 and applicant documentation 108 may include any additional, or alternate, data identifying and characterizing, respectively, the corresponding home mortgage, HELOC, or other RESL product and the one or more applicants that would appropriate to support the initial, intermediate, or final decision on the pre-approval of the corresponding application by the underwriter. Further, although not illustrated in FIG. 1, application data 104 may also include, for the corresponding application, additional elements of applicant documentation characterizing an initial submission of documentation, and one or more intermediate submissions of documentation, during the temporal interval prior to the final submission of documentation supporting the final decision on the pre-approval of the corresponding application, e.g., applicant documentation 108 described herein.

Further, as illustrated in FIG. 1, source system 102B may also be associated with, or operated by, the financial institution, and may establish, within the one or more tangible, non-transitory memories, a data repository 109 that maintains elements of data identifying or characterizing one or more existing customers of the financial institution and interactions between these customers and the financial institution, such as, but not limited to, elements of customer profile data 110, elements of account data 112, and elements of transaction data 114. In some instances, the elements of customer profile data 110 may include, but are not limited to, one or more unique customer identifiers (e.g., an alphanumeric identifier, an alphanumeric character string, such as a login credential or a customer name, etc.), residence data (e.g., a street address, a city or town of residence, etc.), other elements of contact information (e.g., a mobile number, an email address, etc.), values of demographic parameters that characterize the particular customer (e.g., ages, occupations, marital status, etc.), and other data characterizing the relationship between the particular customer and the financial institution (e.g., a customer tenure at the financial institution, etc.).

In some instances, the elements of account data 112 may identify and characterize one or more financial products or financial instruments issued by the financial institution to corresponding ones of the existing customers. For example, the elements of account data 112 may include, for each of the financial products issued to corresponding ones of the existing customers, one or more identifiers of the financial product (e.g., an alphanumeric product, an account number, expiration data, card-security-code, etc.), one or more unique customer identifiers (e.g., an alphanumeric identifiers, an alphanumeric character string, such as a login credential or a customer name, etc.), and additional information characterizing a balance or current status of the financial product or instrument (e.g., payment due dates or amounts, delinquent accounts statuses, etc.). Examples of these financial products may include, but are not limited to, one or more deposit accounts (e.g., a savings account, a checking account, etc.), one or more brokerage or retirements accounts, and one or more secured credit or lending products (e.g., a RESL product, an auto loan, etc.). The financial products may also include one or more unsecured credit products, such as, but are not limited to, a credit-card account, a personal loan, or an unsecured line-of-credit.

Further, the elements of transaction data 114 may identify and characterize initiated, settled, or cleared transactions involving respective ones of the existing customers and corresponding ones of the issued financial products. Examples of these transactions include, but are not limited to, purchase transactions, bill-payment transactions, electronic funds transfers, currency conversions, purchases of securities, derivatives, or other tradeable instruments, electronic funds transfer (EFT) transactions, peer-to-peer (P2P) transfers or transactions, or real-time payment (RTP) transactions. For instance, and for a particular transaction involving a corresponding customer and corresponding financial product, the elements of transaction data 114 may include, but are limited to, a customer identifier of the corresponding customer (e.g., the alphanumeric character string described herein, etc.), a counterparty identifier (e.g., an alphanumeric character string, a counterparty name, etc.), an identifier of the corresponding financial product (e.g., a tokenized account number, expiration data, card-security-code, etc.), and values of one or more parameters of the particular transaction (e.g., a transaction amount, a transaction date, etc.).

The disclosed embodiments are, however, not limited to these exemplary elements of customer profile data 110, account data 112, or transaction data 114 and in other instances, the elements of customer profile data 110, account data 112, and transaction data 114 may include, respectively, any additional or alternate elements of data that identify and characterize the customers of the financial institution and their relationships or interactions with the financial institution, financial products issued to these customers by the financial institution, and transactions involving corresponding ones of the customers and the issued financial products. Further, although stored in FIG. 1 within data repositories maintained by source system 102B, the exemplary elements of customer profile data 110, account data 112, or transaction data 114 may be maintained by any additional or alternate computing system associated with the financial institution, including, but not limited to, within one or more tangible, non-transitory memories of FI computing system 130.

Further, source system 102C may be associated with, or operated by, one or more judicial, regulatory, governmental, or reporting entities external to, and unrelated to, the financial institution. For example, source system 102C may be associated with, or operated by, a reporting entity, such as a credit bureau, and source system 102C may maintain, within the corresponding one or more tangible, non-transitory memories, a source data repository 115 that includes elements of credit-bureau data 116 associated with one or more existing (or prospective) customers of the financial institution. In some instances, and for a particular one of the existing (or prospective) customers of the financial institution, the elements of credit-bureau data 116 may include, but are not limited to, a unique identifier of the particular customer (e.g., an alphanumeric identifier or login credential, a customer name, etc.), a current credit score or information establishing a temporal evolution of credit scores for the particular customer, information identifying one or more financial products currently or previously held by the particular customer (e.g., the financial products issued by the financial institution, financial products issued by other financial institutions), information identifying a history of payments associated with these financial products, information identifying negative events associated with the particular customer (e.g., missed payments, collections, repossessions, etc.), and information identifying one or more credit inquiries involving the particular customer (e.g., inquiries by the financial institution, other financial institutions or business entities, etc.).

In some instances, FI computing system 130 may perform operations that establish and maintain one or more centralized data repositories within corresponding ones of the tangible, non-transitory memories. For example, as illustrated in FIG. 1, FI computing system 130 may establish an aggregated data store 132, which maintains, among other things, elements of application data 104 (including the corresponding application identifiers, elements of decision data and temporal data, and elements of product data 106 and applicant documentation 108), customer profile data 110, account data 112, transaction data 114, and credit-bureau data 116 that characterize one or more of the existing (or prospective) customers of the financial institution. FI computing system 130 may perform operations, described herein, to ingest the elements of application data 104, customer profile data 110, account data 112, transaction data 114, and credit-bureau data 116 for one or more of source systems 102, and aggregated data store 132 may, in some instances, correspond to a data lake, a data warehouse, or another centralized repository established and maintained, respectively, by the distributed components of FI computing system 130, e.g., such an HDFS, etc.

For example, FI computing system 130 may execute one or more application programs, elements of code, or code modules that, in conjunction with the corresponding communications interface (not illustrated in FIG. 1), establish a secure, programmatic channel of communication with each of source systems 102, including source systems 102A, 102B, and 102C, and may perform operations that access and obtain all, or a selected portion, of the elements of application data 104, customer profile data 110, account data 112, transaction data 114, and credit-bureau data 116 maintained by corresponding ones of source systems 102A, 102B, and 102C.

As illustrated in FIG. 1, source system 102A may perform operations that obtain all, or a selected subset, of the elements of application data 104 (including the corresponding application identifiers, elements of decision data and temporal data, and elements of product data 106 and applicant documentation 108) from source data repository 103, and transmit the obtained portions of application data 104 across network 120 to FI computing system 130. Further, source system 102B may perform operations that obtain all, or a selected subset, the elements of customer profile data 110, account data 112, and transaction data 114 from data repository 109, and transmit the obtained elements of customer profile data 110, account data 112, and transaction data 114 across network 120 to FI computing system 130. Source system 102C may also perform operations that obtain all, or a selected portion, of the elements of credit-bureau data 116 from source data repository 115, and transmit the obtained elements of credit-bureau data 116 across network 120 to FI computing system 130.

In some instances, and prior to transmission across network 120 to FI computing system 130, source systems 102A, 102B, and 102C may perform operations that encrypt, respectively, portions of the elements of application data 104, portions of the elements of customer profile data 110, account data 112, and transaction data 114, and portions of the elements of credit-bureau data 116 using a corresponding encryption key, such as, but not limited to, a corresponding public cryptographic key associated with FI computing system 130. Further, although not illustrated in FIG. 1, each additional, or alternate, one of source systems 102 may perform any of the exemplary processes described herein to obtain, encrypt, and transmit additional, or alternate, elements of locally maintained application, customer profile, account, transaction, and/or credit-bureau data across network 120 to FI computing system 130.

A programmatic interface established and maintained by FI computing system 130, such as application programming interface (API) 134, may receive: (i) the elements of application data 104 (including the corresponding application identifiers, elements of decision data and temporal data, and elements of product data 106 and applicant documentation 108) from source system 102A; (ii) the elements of customer profile data 110, account data 112, and transaction data 114 from source system 102B; and (iii) the elements of credit-bureau data 116 from source system 102C. As illustrated in FIG. 1, API 134 may route the elements of application data 104, customer profile data 110, account data 112, transaction data 114, and credit-bureau data 116 to a data ingestion engine 136 executed by the one or more processors of FI computing system 130. As described herein, portions of the elements of application data 104, customer profile data 110, account data 112, transaction data 114, and credit-bureau data 116 may be encrypted, and executed data ingestion engine 136 may perform operations that decrypt each of the encrypted portions using a corresponding decryption key, e.g., a private cryptographic key associated with FI computing system 130.

Executed data ingestion engine 136 may also perform operations that store the elements of application data 104, customer profile data 110, account data 112, transaction data 114, and credit-bureau data 116 in the one or more tangible, non-transitory memories of FI computing system 130, e.g., as ingested customer data 138 within aggregated data store 132. Although not illustrated in FIG. 1, executed data ingestion engine 136 may also store, within aggregated data store 132, the elements of ingested customer data 138 in conjunction with additional, or alternate, elements of application, customer profile, account, transaction, and credit-bureau data ingested from corresponding ones of source systems 102A, 102B, and 102C by executed data ingestion engine 136 during one or more prior temporal intervals. In some instances, each of the ingested elements of application data 104, customer profile data 110, account data 112, transaction data 114, and credit-bureau data 116 may be associated with additional elements of temporal data that characterize a date or time at which executed ingestion engine 136 received the corresponding elements of application, customer profile, account, transaction, or credit-bureau data from one or more of source systems 102 and stored the corresponding elements of application, customer profile, account, transaction, or credit-bureau data within aggregated data store 132 (e.g., “ingested” the corresponding elements of customer profile, account, transaction, or credit-bureau data).

As illustrated in FIG. 1, a pre-processing engine 140 executed by the one or more processors of FI computing system 130 may access the elements of application data 104 maintained within ingested customer data 138, including the corresponding application identifiers, elements of decision data and temporal data, and elements of product data 106 and applicant documentation 108, and may perform any of the exemplary data-processing operations described herein to parse the accessed elements of application data 104, to selectively aggregate, filter, and process the accessed elements of application data 104, and to generate pre-processed data records 142 that characterize corresponding ones of the applications for the home mortgages, HELOCs, and other RESL products, each of the one or more applicants involved in the corresponding ones of the applications, and the final decisions on pre-approval for the corresponding ones of the applications (e.g., by an underwriter). In some instances, executed pre-processing engine 140 may store the pre-processed data records within the one or more tangible, non-transitory memories of FIG. computing system 130, such as within a pre-processed data store 143.

By way of example, executed pre-processing engine 140 may obtain data characterizing one or more filtration criteria associated with the adaptive training of the exemplary machine-learning or artificial-intelligence processes described herein, and executed pre-processing engine 140 may perform operations that filter the accessed elements of application data 104 and exclude one or more of the accessed elements of application data 104 characterizing corresponding applications, or corresponding final decisions, that are inconsistent with at least one of the one or more filtration criteria, e.g., to generated “filtered” elements of application data. In some instances, executed pre-processing engine 140 may perform any of the exemplary processes described herein to process and/or aggregate the filtered elements of application data 104 and generate corresponding ones of pre-processed data records 142, which characterize corresponding ones of the applications for the home mortgages, HELOCs, and other RESL products that are consistent with the one or more filtration criteria.

For instance, the accessed elements of application data 104 may characterize not only applications for home mortgages, HELOCs, and other RESL products having final pre-approval decisions rendered manually by underwriters associated with the financial institution, but also applications for home mortgages, HELOCs, and other real-estate secured lending products subject to pre-approval in accordance with one or more programmatic, static or rules-based operations implemented by a computing system or device of the financial institution, such as FI computing system 130, a device disposed at a physical branch of the financial institution, or by an application program executed at a device operable by an applicant (e.g., an “auto-decisioned” pre-approval). Further, and as described herein, the accessed elements of application data 104 may also identify and characterize not only the final decision on pre-approval for corresponding ones of the applications, but also an initial submission and one or more intermediate submissions of documentation in support of the corresponding ones of the applications (and the initial and intermediate underwriter decisions associated with these initial or intermediate submissions). In some examples, the one or more filtration criteria may exclude, from the filtered elements of application data 104, those elements characterizing applications subject to auto-decisioned pre-approval, and further, those elements that characterize initial or intermediate submissions of applicant documentation.

Further, while certain elements of application data 104 may characterize applications for home mortgages, HELOCs, and other RESL products associated with final decisions that pre-approve, or alternatively, decline the corresponding application, other elements of application data 104 characterize applications for home mortgages, HELOCs, and other real-estate secured lending products associated with final decisions that conditionally or tentatively pre-approve or decline to pre-approve the corresponding application (e.g., recommended decisions, expected denials, etc.), or that waive the pre-approval of the corresponding application. In some instances, the one or more filtration criteria may also exclude, from the filtered elements of application data 104, those elements characterizing applications associated with final decisions that tentatively or conditionally pre-approve (or decline to pre-approve) the corresponding application, or that waive the pre-approval. The disclosed embodiments are, however, not limited to these exemplary filtration criteria, and in other instances, executed pre-processing engine 140 may perform operations that filter the elements of application data 104 in accordance with any additional, or alternate, filtration criterion that would be appropriate to the adaptive training of the exemplary machine-learning or artificial-intelligence processes described herein, to the applications for the applications for home mortgages, HELOCs, and other RESL products, or to the involved applicants.

By way of example, the elements of application data 104 may identify an application for a home mortgage may be characterized by a unique application identifier (e.g., “APPID”) and associated with two individual applicants, each of which may represent existing customers of the financial institution assigned corresponding, unique, applicant identifiers (e.g., “CUSTID1” and “CUSTID2,” respectively). The application may, for example, be associated with a single submission of documentation characterizing each of the two individual applicants, and on May 1, 2023 (e.g., a corresponding decision date), an underwriter may elect to pre-approve the application for the home mortgage (e.g., a corresponding final decision). In some instances, executed pre-processing engine 140 may access the elements of application data 104 associated with the pre-approved application, e.g., the application identifier (e.g., “APPID”), each of the unique applicant identifiers (e.g., “CUSTID1” and “CUSTID2”), decision data characterizing the final decision to pre-approve the application, and temporal data specifying the decision date of May 1, 2023. Further, executed pre-processing engine 140 may also perform operations that identify and obtain a portion of product data 106 that characterizes the home mortgage associated with the pre-approved application, and that identify and obtain a portion of applicant documentation 108 that corresponds to the single submission of documentation characterizing the applicants having applicant identifiers “CUSTID1” and “CUSTID2.”

Executed pre-processing engine 140 may perform operations, described herein, that establish a consistency between the pre-approved application for the home mortgage and the one or more filtration criteria, and based on the established consistency, executed pre-processing engine 140 may perform operations that consolidate the data elements obtained from application data 104, as described herein, and may generate a corresponding one of pre-processed data records 142, e.g., data record 142A, that identifies and characterizes the pre-approved application. In some instances, data record 142A may include the application identifier for the pre-approved application for the home mortgage (e.g., “APPID”), each of the applicant identifiers for the two individual applicants (e.g., “CUSTID1” and “CUSTID2”), the decision data characterizing the final pre-approval decision, the temporal data specifying the decision date of May 1, 2023, the obtained portion of product data 106, which characterizes the home mortgage associated with the pre-approved application, and the obtained portion of applicant documentation 108, which corresponds to the single submission of documentation characterizing each of the two individual applicants.

In some instances, executed pre-processing engine 140 may consolidate and/or aggregate certain of the obtained data elements, through an invocation of an appropriate Java-based SQL “join” command (e.g., an appropriate “inner” or “outer” join command, etc.). Further, executed pre-processing engine 140 may perform any of the exemplary processes described herein to generate another one of pre-processed data records 142 for each additional, or alternate, one of the applications for home mortgages, HELOCs, and other RESL products characterized by the elements of application data 104 and deemed consistent with the one or more filtration criteria.

By way of example, as illustrated in FIG. 1, pre-processed data record 142A may include an application identifier 144 (e.g., “APPID” of the pre-approved application for the home mortgage), applicant identifiers 146 (e.g., applicant identifiers “CUSTID1” and “CUSTID2” of the two individual applicants), decision data 148 characterizing the final decision to pre-approve the application for the home mortgage, and temporal data 150 identifying the final decision date (e.g., “2023-05-01”). Further, pre-processed data record 142A may also include elements of product data 152 that identify and characterize the home mortgage associated with the pre-approved application, and elements of applicant documentation 154 that identifies and characterizes each of the one or more applicants involved in the pre-approved application, e.g., the two individual applicants associated with applicant identifiers 146.

As described herein, executed pre-processing engine 140 may perform any of the exemplary processes described herein to extract the elements of product data 152 from a corresponding portion of product data 106 maintained within application data 104 (e.g., based on an alphanumeric identifier of the home mortgage), and the elements of applicant documentation 154 may correspond to information associate with the single submission of documentation characterizing the two individual applicants, which executed pre-processing engine 140 may obtain from applicant documentation 108 maintained within application data 104 (e.g., based on applicant identifiers 146). Further, and as described herein, the elements of product data 152 may include, but are not limited to, the alphanumeric identifier of the home mortgage, a value of one or more parameters of the home mortgage, such as a loan amount, a loan term, or information characterizing a fixed or variable interest rate, and the elements of applicant documentation 154 may include, but are not limited to, each of applicant identifiers 146, information characterizing a parcel of real estate that servers as collateral for the home mortgage (e.g., an address, a digital copy of a deed or conveyance, or a current assessment, one or more digital images, etc.).

The elements of applicant documentation 154 may also include information that characterizes a current residence and employment of the applicants (e.g., the two single applicants associated with applicant identifiers 146), a current or temporal evolution of an income of the applicants, a current or temporal evolution of a value of assets and liabilities held by the applicants, a current or temporal evolution of a credit score of the applicants and/or an employment or tax history of the applicants. Executed pre-processing engine 140 may perform additional operations, described herein, to generate additional ones of pre-processed data records 142 for each additional, or alternate, application for a home mortgages, HELOC, or other RESL products involving corresponding applicants and characterized by the filtered elements of application data 104.

Further, and as described herein, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™, Amazon Web Services™ Google Cloud™, or another third-party provider. In some instances, prior to ingestion by one or more computing systems of a publicly accessible portion of the distributed or cloud-based computing cluster of FI computing system 130 (e.g., an insecure or publicly accessible partition of the distributed or cloud-based computing cluster of FI computing system 130), or prior to ingestion by the publicly accessible distributed or cloud-based computing cluster, FI computing system 130 may also perform operations that selectively tokenize or obfuscate elements of sensitive or confidential customer, account, transaction, or credit-bureau data associated with applicants involved in the applications for home mortgages, HELOCs, or other RESL products and maintained within corresponding ones of pre-processed data records 142.

For example, a tokenization engine 156 executed by the one or more processors of FI computing system 130, or a tokenization system accessible to FI computing system 130 across network 120 via a corresponding programmatic interface (not illustrated in FIG. 1), may perform operations that access one or more pre-processed data records 142, tokenize or obfuscate the elements of sensitive or confidential customer, account, transaction, or credit-bureau data (e.g., in accordance with a corresponding tokenization schema), and store the now-tokenized data records within pre-processed data store 143, e.g., as tokenized data records 158. For example, as illustrated in FIG. 1, executed tokenization engine 156 may access data record 142A of pre-processed data records 142, perform operations that tokenize or obfuscate the sensitive or confidential information within the elements of product data 152 and applicant documentation 154, and store the now-tokenized elements of product data and applicant documentation within a corresponding one of tokenized data records 158, e.g., as elements of tokenized product data 160 and elements of tokenized applicant documentation 162 within tokenized data record 158A.

In some instances, FI computing system 130 may perform any of the exemplary operations described herein to train adaptively a machine-learning or artificial-intelligence process to predict an expected, final decision on pre-approval of an application for a home mortgage, a HELOC, or another RESL product involving one or more discrete applicants in real-time and on-demand upon receipt from a corresponding digital channel using training and validation datasets associated with a first prior temporal interval (e.g., an in-time training and validation interval), and using testing datasets associated with a second, and distinct, prior temporal interval (e.g., an out-of-time “testing” interval). The final decision may, as described herein, correspond to a positive decision (e.g., pre-approve of the application) or a negative decision (e.g., decline to pre-approve the application). Further, and as described herein, the machine-learning or artificial-intelligence process may include an ensemble or decision-tree process, such as a gradient-boosted decision-tree process (e.g., the XGBoost model), and the training and validation datasets may include, but are not limited to, values of adaptively selected features obtained, extracted, or derived from the consolidated data records maintained within pre-processed data store 143, e.g., from data elements maintained within the discrete data records of tokenized data records 158.

For example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within pre-processed data store 143.

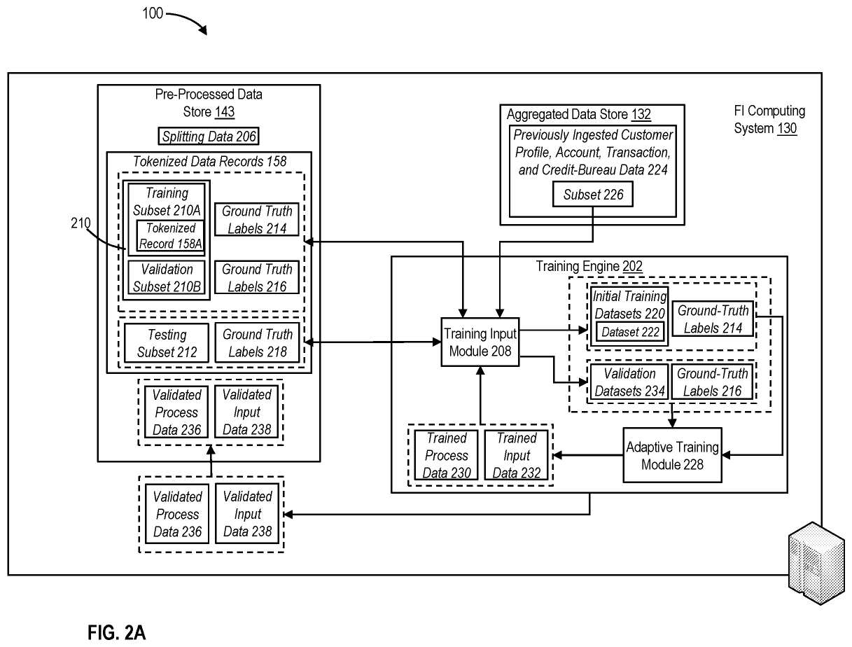

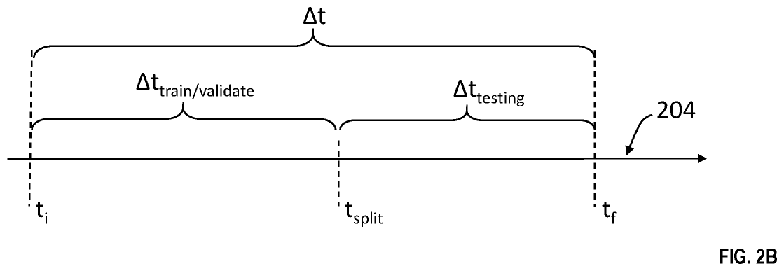

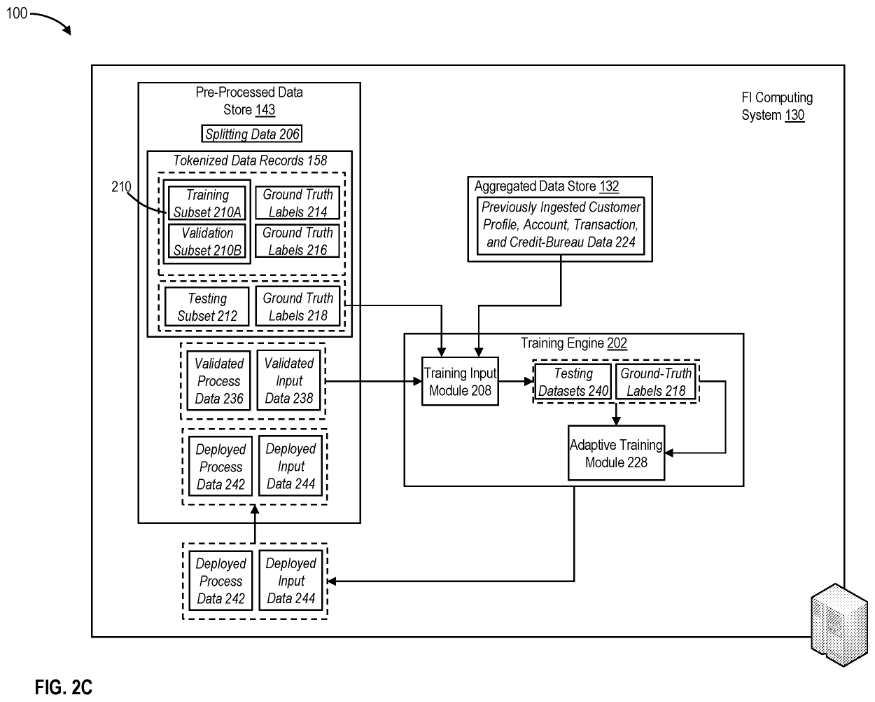

Referring to FIG. 2A, a training engine 202 executed by the one or more processors of FI computing system 130 may access the consolidated data records maintained within pre-processed data store 143, such as, but not limited to, the discrete data records of tokenized data records 158. As described herein, each of the tokenized data records, such as discrete data record 152A of tokenized data records 158, may identify and characterize an application for a home mortgage, a HELOC, or another RESL product associated with a corresponding, final decision (e.g., by an underwriter) rendered on a corresponding decision date. For example, each of the tokenized data records, including as discrete data record 152A of tokenized data records 158, may include a unique application identifier of a corresponding one of the applications (e.g., application identifier 144 of FIG. 1), an identifier of each of the one or more applicants involved in the corresponding application (e.g., applicant identifiers 146 of FIG. 1), decision data characterizing the final decision on pre-approval for the corresponding application (e.g., decision data 148 of FIG. 1), temporal data identifying a date of the final decision (e.g., temporal data 150 of FIG. 1), tokenized elements of product data characterizing the home mortgage, HELOC, another RESL product associated with the corresponding application (e.g., elements of tokenized product data 160 of FIG. 1), and tokenized elements of applicant documentation characterizing each of the one or more applicants (e.g., tokenized applicant documentation 162 of FIG. 1).

In some instances, executed training engine 202 may parse the accessed consolidated data records, and based on the corresponding elements of temporal data, which identify the date of final decision on the temporal approval of the corresponding application, determine that the discrete data records of tokenized data records 158 characterize applications for home mortgage, HELOCs, or other RESL products having final decision dates dispersed across a range of prior temporal intervals. Further, executed training engine 202 may also perform operations that decompose the determined range of prior temporal intervals into a corresponding first subset of the prior temporal intervals (e.g., the in-time training and validation interval described herein) and into a corresponding second, subsequent, and disjoint subset of the prior temporal intervals (e.g., the out-of-time testing interval described herein). For example, as illustrated in FIG. 2B, the range of prior temporal intervals (e.g., shown generally as Δt along timeline 204 of FIG. 2B) may be bounded by, and established by, temporal boundaries ti and tr. Further, the decomposed first subset of the prior temporal intervals (e.g., shown generally as an in-time training and validation interval Δt_{train/validate} along timeline 204 of FIG. 2B) may be bounded by temporal boundary ti and a corresponding splitting point tₛₚₗᵢₜ along timeline 204, and the decomposed second subset of the prior temporal intervals (e.g., shown generally as out-of-time testing interval Δt_{testing} along timeline 204 of FIG. 2B) may be bounded by splitting point tₛₚₗᵢₜ and temporal boundary t_{f}.

Referring back to FIG. 2A, executed training engine 202 may generate elements of splitting data 206 that identify and characterize the determined temporal boundaries of the discrete data records of tokenized data records 158 (e.g., temporal boundaries ti and t_{f}) and the range of prior temporal intervals established by the determined temporal boundaries Further, the elements of splitting data 206 may also identify and characterize the temporal splitting point (e.g., the splitting point tₛₚₗᵢₜ described herein) that separates the first subset of the prior temporal interval (e.g., the in-time training and validation interval Δt_{train/validate} and corresponding boundaries described herein), and the second, and subsequent subset of the prior temporal intervals (e.g., the out-of-time testing interval Δt_{testing} and corresponding boundaries described herein). As illustrated in FIG. 2A, executed training engine 202 may store the elements of splitting data 206 within the one or more tangible, non-transitory memories of FI computing system 130, e.g., within pre-processed data store 143.

As described herein, each of the prior temporal intervals may correspond to a one-month interval, and executed training engine 202 may perform operations that establish adaptively the splitting point between the corresponding temporal boundaries such that a predetermined first percentage of the discrete data records of tokenized data records 158 characterize applications having final decision dates (e.g., as specified by corresponding elements of the temporal data) disposed within the training interval, and such that a predetermined second percentage of the discrete data records of tokenized data records 158 characterize applications having final decision dates (e.g., as specified by corresponding elements of temporal data) disposed within the validation interval. For example, the first predetermined percentage may correspond to seventy percent of the consolidated data records, and the second predetermined percentage may corresponding to thirty percent of the consolidated data records, although in other examples, executed training engine 202 may compute one or both of the first and second predetermined percentages, and establish the decomposition point, based on the range of prior temporal intervals, a quantity or quality of the discrete data records of tokenized data records 158, or a magnitude of the temporal intervals (e.g., one-month intervals, two-week intervals, one-week intervals, one-day intervals, etc.).

In some examples, a training input module 208 of executed training engine 202 may perform operations that access the discrete data records of tokenized data records 158, which may be maintained within pre-processed data store 143. As described herein, each of the accessed data records (e.g., the discrete data records within tokenized data records 158) may identify and characterize a corresponding application for an application for a home mortgage, a HELOC, or another RESL product associated with a corresponding final decision on pre-approval (e.g., by an underwriter) rendered on a corresponding decision date. In some instances, and based on portions of splitting data 206, executed training input module 208 may perform operations that parse the discrete data records of tokenized data records 158 and determine that: (i) a subset 210 of these tokenized data records are associated with applications having final decisions dates disposed within the in-time training and validation interval Δt_{train/validate}, and as such, may be appropriate to train adaptively and validate the gradient-boosted decision model during the in-time training and validation interval; and (ii) a subset 212 of these tokenized data records are associated with applications having final decision dates disposed within the out-of-time testing interval Δt_{testing}, and as such, may be appropriate to testing the adaptively trained and validated gradient-boosted decision model on previously unseen data prior to deployment.

Executed training input module 208 may also perform operations that partition subset 210 of the tokenized data records into a corresponding, in-sample training subset 210A of the tokenized data records appropriate to train adaptively the gradient-boosted decision process during the in-time training and validation interval Δt_{train/validate}, and a corresponding, out-of-sample validation subset 210B appropriate to validate the adaptively trained gradient-boosted decision process during the in-time training and validation interval Δt_{train/validate}. In some instances, executed training input module 208 may perform operations that partition the tokenized data records of first subset 210 such that a first predetermined percentage of the tokenized data records are assigned to in-sample training subset 210A, and such that a second predetermined percentage of the tokenized data records are assigned to out-of-sample validation subset 210B. Examples of the first predetermined percentage include, include, but are not limited to, 50%, 75%, or 90%, and corresponding examples of the second predetermined percentage include, but are not limited to, 50%, 25%, or 10% (e.g., a difference between 100% and the corresponding first predetermined percentage), although in other examples, the first and second predetermined percentages may be determined adaptively by executed training input module 208 based on, among other things, one or more statistical characteristics of the tokenized records assigned to subset 210.

Executed training input module 208 may also perform operations that generate information characterizing a ground-truth label associated with each of the tokenized data records maintained within corresponding ones of training subset 210A and validation subset 210B of first subset 210, and within subset 212. As described herein, while each of tokenized data records may be associated may be associated with a corresponding application for a home mortgage, HELOC, or other RESL product associated with a corresponding final decision on pre-approval rendered on a corresponding decision date, one or more of these applications may be associated with, and supported by, an initial submission of documentation and one or more intermediate submissions that modify, clarify, or augment certain of the previously submitted elements of documentation (e.g., to reflect a reduction in debt levels, an increase in income, a resolution of a negative credit event, etc.) prior to the issuance of a final decision by the underwriter. Further, the initial submission and/or one or more of these intermediate submissions may themselves be associated with corresponding initial or intermediate decision by the underwriter, e.g., based on the applicant documentation included within respective ones of the initial or intermediate submission.

In some instances, executed training input module 208 may establish the final decision by the underwriter as the corresponding ground truth label for the each of the applications (e.g., as rendered on the final decision date), and for corresponding ones of the tokenized data records maintained, respectively, within training subset 210A, validation subset 210B, and subset 212. For example, and for each of the tokenized data records maintained within training subset 210A, executed training input module 208 may access and obtain a corresponding element of decision data, which characterizes the associated application for the home mortgage, HELOC, or other RESL product as either “pre-approved” or “declines,” and generate a corresponding on ground truth labels 214 that labels the corresponding tokenized data record as a positive target (e.g., indicative of an application pre-approved by the underwriter) or a negative target (e.g., indicative of an application declined by the underwriter). As illustrated in FIG. 2A, executed training input module 208 may perform operations that store ground truth labels 214 in corresponding portion of pre-processed data store 143, e.g., in conjunction or association with training subset 210A within tokenized data records 158.

Further, and for each of the tokenized data records maintained within validation subset 210B, executed training input module 208 may access and obtain a corresponding element of decision data, and using any of the exemplary processes described herein, generate a corresponding of ground truth labels 216 that labels the corresponding tokenized data record as a positive target (e.g., indicative of an application pre-approved by the underwriter) or a negative target (e.g., indicative of an application declined by the underwriter). Executed training input module 208 may also access and obtain a corresponding element of decision data maintained within each of the tokenized data records maintained within subset 210, and using any of the exemplary processes described herein, generate a corresponding one of ground truth labels 218 that labels the corresponding tokenized data record as a positive target (e.g., indicative of an application pre-approved by the underwriter) or a negative target (e.g., indicative of an application declined by the underwriter). As illustrated in FIG. 2A, executed training input module 208 may perform operations that store ground truth labels 216 and 218 in corresponding portions of pre-processed data store 143, e.g., in conjunction or association with respective ones of validation subset 210B and subset 212.

Executed training input module 208 may perform operations that generate one or more initial training datasets 220 based on the tokenized data records maintained within training subset 210A, and additionally, or alternatively, based on elements of ingested customer profile, account, transaction, or credit-bureau data maintained within the one or more tangible, non-transitory memories of FI computing system 130 (e.g., within aggregated data store 132). In some instances, the plurality of initial training datasets 220 may, when provisioned to an input layer of the gradient-boosted decision-tree process described herein, enable executed training engine 202 to train adaptively the gradient-boosted decision-tree process to predict an expected final decision regarding a pre-approval of an application for a home mortgage, a HELOC, or another RESL product in real-time and on-demand upon receipt from a corresponding digital channel.

As described herein, each of the plurality of initial training datasets 220 may be associated with a corresponding one of the applications for the home mortgages, HELOCs, or other RESL products, which may be characterized by a corresponding one of the tokenized data records of in-sample training subset 210A, and which are associated with a final decision date disposed within the in-time training and validation interval Δt_{train/validate}. In some instances, each of the plurality of initial training datasets 220 may include an application identifier associated with the corresponding application (e.g., application identifier 144 of FIG. 1), an applicant identifier associated with each of the applicants (e.g., applicant identifiers 146 of FIG. 1), and temporal data specifying the final decision date rendered by the underwriter (e.g., temporal data 150 of FIG. 1).

Further, each of the plurality of initial training datasets 220 may also include elements of data (e.g., feature values) that characterize the application for the home mortgage, HELOC, or other RESL product and additionally, or alternatively, each or a subset of the applicants involved in the application. Each of initial training datasets 220 may also be associated with a corresponding one of ground-truth labels 214, which associates the corresponding one of initial training datasets 220 with a positive target (e.g., indicative of a decision to pre-approve a corresponding application) or a negative target (e.g., indicative of a decision to decline a corresponding application).

In some instances, executed training input module 208 may perform operations that identify, and obtain or extract, one or more of the features values of each of initial training datasets 220 from a corresponding one of the tokenized data records maintained within training subset 210A, and additionally, or alternatively, from elements of previously ingested customer profile, account, transaction, or credit-bureau data that characterize the one or more applicants involved in the corresponding application. For example, and for a particular one of initial training datasets 220, executed training input module 208 may access one or more elements of tokenized product data or tokenized applicant documentation maintained within the corresponding tokenized data record within training subset 210A, and may perform operations that obtain or extract one, or more, of the feature values from the accessed elements of tokenized product data or tokenized applicant documentation.

Executed training input module 208 may obtain, from the tokenized data record of training subset 210A associated with the particular one of initial training datasets 220, an applicant identifier associated with each of the one or more applicants involved in the corresponding application and temporal data characterizing the final decision date for the corresponding application. Executed training input module 208 may also perform operations that access aggregated data store 132, and identify one or more elements of previously ingested customer profile, account, transaction, or credit-bureau data that include, reference, or are associated with each of the obtained applicant identifiers and as such, characterize each applicant involved in the corresponding application. Further, as described herein, each of the identified elements of customer profile, account, transaction, or credit-bureau data may be associated with additional temporal data that characterizes an ingestion date associated with the corresponding elements of customer profile, account, transaction, or credit-bureau data.

Based on the final decision date associated with the corresponding application, and the ingestion dates associated with the identified elements of previously ingested customer profile, account, transaction, or credit-bureau data, executed training input module 208 may select a subset of the identified elements of previously ingested customer profile, account, transaction, or credit-bureau data that were ingested by FI computing system 130 prior to the final decision date of the corresponding application and as such, that would have been available to the underwriter on, or before, the date on which the final decision date for the corresponding application. Executed training input module 208 may, for example, obtain the subset of the identified elements of previously ingested customer profile, account, transaction, or credit-bureau data from aggregated data store 132, and may perform operations that obtain or extract one or more of the features values of the particular one of initial training datasets 220 from the subset of the previously ingested elements of customer profile, account, transaction, or credit-bureau data.

By way of example, training subset 210A may include tokenized data record 158A, which characterizes the pre-approved application for the home mortgage having a final decision data of May 1, 2023, and executed training input module 208 may perform any of the exemplary processes described herein to generate a corresponding one of initial training datasets 220, such as initial training dataset 222, associated with the pre-approved application for the home mortgage. In some instances, executed training input module 208 may parse tokenized data record 158A and obtain temporal data 150, which specifies the final decision date of May 1, 2023, and applicant identifiers 146 associated with the two individual applicants involved in the pre-approved application for the home mortgage (e.g., “CUSTID1” and “CUSTID2”). As described herein, executed training input module 208 may obtain or extract one or more feature values of initial training dataset 222 from the elements of tokenized product data 160 and tokenized applicant documentation 162 maintained within tokenized data record 158A.

Further, as illustrated in FIG. 2A, executed training input module 208 may also access aggregated data store 132 and determine that one or more elements 224 of previously ingested customer profile, account, transaction, or credit-bureau data are associated with, or reference, each of applicant identifier 146 and as such, characterize the two individual applicants involved in the pre-approved application for the home mortgage. Further, executed training input module 208 may also parse the elements 224 of previously ingested customer profile, account, transaction, or credit-bureau data, and their corresponding ingestion dates, to identify a subset 226 of elements 224 that were ingested by FI computing system 130 prior to the May 1, 2023, final decision date of the pre-approved application for the home mortgage and as such, would have been available to the underwriter on, or before, the final decision date. Executed training input module 208 may, for example, obtain subset 226 from aggregated data store 132, and may perform operations, described herein, that obtain or extract one or more of the features values of initial training dataset 222 from subset 226.

Examples of these obtained or extracted feature values may include, but are not limited to, an amount of debt held by one or more of the applicants, a digital channel used to submit the application, a loan-to-value ratio, an amount of the loan, data characterizing a relationship between one or more of the applicants and the financial institution (e.g., a customer tenure, etc.), data identifying one or more types of financial products held by the one or more of the applicants, or a balance or an amount of available credit (or funds) associated with one or more financial instruments held by the one or more of the applicants. Further, although not illustrated in FIG. 2A, executed training input module 208 may perform any of the exemplary processes described herein to identify, and obtain or extract, one or more of the features values of each additional, or alternate, ones of initial training datasets 220 from a corresponding one of the tokenized data records maintained within training subset 210A and further, from one or more temporally relevant elements of previously ingested customer profile, account, transaction, or credit-bureau data that characterize the one or more applicants involved in the corresponding application.

In some instances, executed training input module 208 may perform operations that compute, determine, or derive one or more of the features values based on elements of data extracted or obtained from a corresponding one of the tokenized data records maintained within training subset 210A, and additionally, or alternatively, from temporally relevant elements of previously ingested customer profile, account, transaction, or credit-bureau data that characterize the one or more applicants involved in the corresponding application, such as, but not limited to, subset 226 of elements 224 of previously ingested customer profile, account, transaction, or credit-bureau data that were ingested by FI computing system 130 prior to the final decision date of the corresponding application, as described herein. Examples of these computed, determined, or derived feature values may include, but are not limited to, a maximum or minimum batch credit score across each of the applicants involved in the corresponding application (e.g., the two individual applicants associated with tokenized data record 158A of training subset 210A, etc.), a maximum or minimum amount of debt held across each of the applicants involved in the corresponding application, and/or sums of balances held in various demand or deposit accounts by the applicants involved in the corresponding application.

Executed training input module 208 may provide initial training datasets 220 and the corresponding ground-truth labels 214 as inputs to an adaptive training module 228 of executed training engine 202. In some instances, and upon execution by the one or more processors of FI computing system 130, adaptive training module 228 may perform operations that establish a plurality of nodes and a plurality of decision trees for the gradient-boosted, decision-tree process (i.e., in accordance with an initial set of process parameters), which may ingest and process the elements of training data (e.g., the customer identifiers, the temporal identifiers, the feature values, etc.) maintained within each of the plurality of initial training datasets 220. Further, and based on the execution of adaptive training module 228, and on the ingestion of each of initial training datasets 220 by the established nodes of the gradient-boosted, decision-tree process, FI computing system 130 may perform operations that adaptively train the gradient-boosted, decision-tree process against the elements of training data included within each of initial training datasets 220 and corresponding ground-truth labels 214. In some examples, during the adaptive training of the gradient-boosted, decision-tree process, executed adaptive training module 228 may perform operations that characterize a relative of importance of discrete features within one or more of initial training datasets 220 through a generation of corresponding Shapley feature values and through a generation of values of probabilistic metrics that average a computed area under curve for receiver operating characteristic (ROC) curves.

In some instances, the distributed components of FI computing system 130 may execute adaptive training module 228, and may perform any of the exemplary processes described herein in parallel to train adaptively the gradient-boosted, decision-tree process against the elements of training data included within each of initial training datasets 220. The parallel implementation of adaptive training module 228 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework).

Through the performance of these adaptive training processes, executed adaptive training module 228 may perform operations that iteratively add, subtract, or combine discrete features from initial training datasets 220 based on the corresponding Shapley feature values or one or more of the generated values of the probabilistic metrics, and that generate one or more intermediate training datasets reflecting the iterative addition, subtraction, or combination of discrete features from corresponding ones of initial training datasets 220, and in some instances, an intermediate set of process parameters for the gradient-boosted, decision-tree process (e.g., to correct errors, etc.). Executed adaptive training module 228 may also perform operations that re-establish the plurality of nodes and the plurality of decision trees for the gradient-boosted, decision-tree process (i.e., in accordance with the intermediate set of process parameters), which may ingest and process the elements of training data maintained within each of the intermediate training datasets. Based on the execution of adaptive training module 228, and on the ingestion of each of the intermediate training datasets by the re-established nodes of the gradient-boosted, decision-tree process, FI computing system 130 may perform operations that adaptively train the gradient-boosted, decision-tree process against the elements of training data included within each of intermediate training datasets and corresponding elements of ground-truth labels and further, that generate additional Shapley feature values and additional values of probabilistic metrics (as described herein) that characterize a relative of importance of discrete features within one or more of intermediate training datasets.

In some instances, executed adaptive training module 228 may implement iteratively one or more of the exemplary adaptive training processes described herein, which iteratively add, subtract, or combine discrete features from corresponding ones of intermediate training datasets based on the corresponding Shapley feature values or one or more of the generated values of the probabilistic metrics, until a marginal impact resulting from a further addition, subtraction, or combination of discrete features values on a predictive output of the gradient-boosted, decision-tree process falls below a predetermined threshold (e.g., the addition, subtraction, or combination of the discrete features values within an updated intermediate training dataset results in a change in a value of one or more of the probabilistic metrics that falls below a predetermined threshold change, etc.). Based on the determination that the marginal impact resulting from the further addition, subtraction, or combination of discrete features values on the predictive output falls below the predetermined threshold, executed adaptive training module 228 may deem complete the training of the gradient-boosted, decision-tree process against the in-time and in-sample initial training datasets 220, and may perform operations that compute one or more candidate process parameters that characterize the adaptively trained, gradient-boosted, decision-tree process, and package the candidate process parameters into corresponding portions of trained process data 230.

In some instances, the candidate process parameters included within trained process data 230 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, executed adaptive training module 228 may also generate trained input data 232, which specifies a composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 2A, executed adaptive training module 228 may provide trained process data 230 and trained input data 232 as inputs to executed training input module 208 of training engine 202, which, in conjunction with executed adaptive training module 228, may perform operations that validate the trained gradient-boosted, decision-tree process against elements of in-time, but out-of-sample, data maintained within the tokenized data records of validation subset 210B. For example, executed training input module 208 may receive trained input data 232, and may perform any of the exemplary processes described herein to generate a plurality of validation datasets 234 based on the tokenized data records maintained within corresponding one of validation subset 210B, and in some instances, based on temporally relevant elements of previously ingested customer profile, account, transaction, or credit-bureau data that characterize one or more applicants involved in the applications for the home mortgages, HELOCs, or other RESL products associated with corresponding ones of the tokenized data records. As described herein, a composition, and a sequential ordering, of features values within each of validation datasets 234 may be consistent with the composition and corresponding sequential ordering set forth in trained input data 232, and each of validation datasets 234 may be associated with a corresponding one of ground-truth labels 216, which may be indicative of the final decision on pre-approval rendered by the underwriter in the corresponding one of the applications (e.g., a positive target associated with a pre-approved application, or a negative target associated with a declined application). Examples of these feature values include, but are not limited to, one or more of the feature values extracted, obtained, computed, determined, or derived by executed training input module 208 and packaged into corresponding potions of initial training datasets 220.

As described herein, the plurality of validation datasets 234 and ground-truth labels 216 may, when provisioned to, and ingested by, the nodes of the decision trees of the adaptively trained, gradient-boosted, decision-tree process (e.g., established in accordance with trained process data 230), enable executed training engine 202 to validate the predictive capability and accuracy of the adaptively trained, gradient-boosted, decision-tree process, for example, based on ground-truth labels 216 associated with corresponding ones of the validation datasets 234, and based on one or more computed metrics, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves.

Referring back to FIG. 2A, executed training input module 208 may provide the plurality of validation datasets 234 and corresponding ground-truth labels 216 as inputs to executed adaptive training module 228. In some instances, executed adaptive training module 228 may obtain trained process data 230 from pre-processed data store 143, and may perform operations that establish the plurality of nodes and the plurality of decision trees for the gradient-boosted, decision-tree process in accordance with each, or a subset, of trained process data 230. As described herein, trained process data 230 for the adaptively trained gradient-boosted, decision-tree process may include, but are not limited to, a learning rate, a number of discrete decision trees (e.g., the “n_estimator” for the adaptively trained, gradient-boosted, decision-tree process), a tree depth characterizing a depth of each of the discrete decision trees, a minimum number of observations in terminal nodes of the decision trees, and/or values of one or more hyperparameters that reduce potential model overfitting (e.g., regularization of pseudo-regularization hyperparameters).

Executed adaptive training module 228 may perform any of the exemplary processes described herein to apply the adaptively trained, gradient-boosted, decision-tree process to the elements of in-time, but out-of-sample, data maintained within respective ones of validation datasets 234, e.g., based on an ingestion and processing of the data maintained within respective ones of validation datasets 234 by the established nodes and decision trees of the adaptively trained, gradient-boosted, decision-tree process. Further, executed adaptive training module 228 may also perform operations that generate elements of output data may be generated through the application of the adaptively trained, gradient-boosted, decision-tree process to a corresponding one of validation datasets 234. In some instances, each of elements of output data may include a predicted final decision on a pre-approval of a corresponding application for a home mortgage, HELOC, another RESL product associated with a corresponding one of validation datasets 234. As described herein, the final pre-approval decision may correspond to a positive decision (e.g., a decision to pre-approve the application) or a negative decision (e.g., a decision to decline to pre-approve the application).

Executed adaptive training module 228 may also perform operations that compute a value of one or more metrics that characterize a predictive capability, and an accuracy, of the adaptively trained, gradient-boosted, decision-tree process based on the generated elements of output data, corresponding ones of validation datasets 234, and corresponding ones of ground-truth labels 216. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, a computed value of an AUC for a receiver operating characteristic (ROC) curve associated with the adaptively trained, gradient-boosted, decision-tree process, and additionally, or alternatively, a computed value of multiclass, one-versus-all area under curve (MAUC) for a ROC. The disclosed embodiments are, however, not limited to these exemplary computed metric values, and in other instances, executed adaptive training module 228 may compute a value of any additional, or alternate, metric appropriate to validation datasets 234, the ground-truth labels, or the adaptively trained, gradient-boosted, decision-tree process

In some examples, executed adaptive training module 228 may also perform operations that determine whether all, or a selected portion of, the computed metric values satisfy one or more threshold conditions for a deployment of the adaptively trained, gradient-boosted, decision-tree process and a real-time application to elements of application, customer profile, account, transaction, and/or credit-bureau data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values and/or MAUC values. In some examples, executed adaptive training module 228 that establish whether one, or more, of the computed recall-based values, the computed precision-based values, or the computed AUC or MAUC values exceed, or fall below, a corresponding one of the predetermined threshold values and as such, whether the adaptively trained, gradient-boosted, decision-tree process satisfies the one or more threshold requirements for deployment.

If, for example, executed adaptive training module 228 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of customer profile, account, transaction, credit-bureau, and/or application data described herein. Executed adaptive training module 228 may perform operations (not illustrated in FIG. 2A) that transmit data indicative of the established inaccuracy to executed training input module 208, which may perform any of the exemplary processes described herein to generate one or more additional training datasets and corresponding ground-truth labels, which may be provisioned to executed adaptive training module 228. In some instances, executed adaptive training module 228 may receive the additional training datasets and corresponding ground-truth labels, and may perform any of the exemplary processes described herein to train further the gradient-boosted, decision-tree process against the elements of training data included within each of the additional training datasets.

Alternatively, if executed adaptive training module 228 were to establish that each computed metric value satisfies threshold requirements, FI computing system 130 may validate the adaptive training of the gradient-boosted, decision-tree process, and may generate validated process data 236 that includes the one or more process parameters of the adaptively trained, gradient-boosted, decision-tree process, such as, but not limited to, each of the process parameters specified within trained process data 230. Further, executed adaptive training module 228 may also generate validated input data 238, which characterizes a composition of an input dataset for the adaptively trained, and now validated, gradient-boosted, decision-tree process and identifies each of the discrete feature values within the input dataset, along with a sequence or position of these feature values within the input dataset. As illustrated in FIG. 2A, executed adaptive training module 228 may perform operations that store validated process data 236 and validated input data 238 within the one or more tangible, non-transitory memories of FI computing system 130, such as pre-processed data store 143.

In some examples, if executed adaptive training module 228 were to establish that each computed metric value satisfies threshold requirements, FI computing system 130 may not only validate the adaptive training of the gradient-boosted, decision-tree process, but also deem the adaptively trained, and now-validated, gradient-boosted, decision-tree process ready for deployment and real-time application to the elements of customer profile, account, transaction, credit-bureau, or application data described herein. In other examples, executed adaptive training module 228 may perform operations that further characterize an accuracy, and a performance, of the adaptively trained, and now-validated, gradient-boosted, decision-tree process against elements of testing data associated with out-of-time testing interval Δt_{testing} (e.g., along timeline 204 of FIG. 2B) and maintained within the tokenized data records of subset 212. In some instances, the further testing of the adaptively trained, and now-validated, gradient-boosted, decision-tree process against the elements of temporally distinct testing data may confirm a capability of the adaptively trained and validated, gradient-boosted, decision-tree process to predict an expected, final decision on a pre-approval of an application for a home mortgage, HELOC, or other RESL product initiated by one or more applicants within a market environment that potentially differs from that characterizing the in-time testing and validation interval, and may further establish the readiness of the adaptively trained and validated, gradient-boosted, decision-tree process for deployment and real-time application to the elements of customer profile, account, transaction, credit-bureau, or application data described herein.

Referring to FIG. 2C, executed training input module 208 may obtain validated input data 238 from pre-processed data store 143, and may perform any of the exemplary processes described herein to generate a plurality of testing datasets 240 based on the tokenized data records maintained within corresponding one of subset 212, and in some instances, based on temporally relevant elements of previously ingested customer profile, account, transaction, or credit-bureau data that characterize one or more applicants involved in the applications for the home mortgages, HELOCs, or other RESL products associated with corresponding ones of the tokenized data records. As described herein, a composition, and a sequential ordering, of features values within each of testing datasets 240 may be consistent with the composition and corresponding sequential ordering set forth in validated input data 238, and each of testing subset 240 may be associated with a corresponding one of ground-truth labels 218, which may be indicative of the final decision on pre-approval rendered by the underwriter in the corresponding one of the applications (e.g., a positive target associated with a pre-approved application, or a negative target associated with a declined application). Examples of these feature values include, but are not limited to, one or more of the feature values extracted, obtained, computed, determined, or derived by executed training input module 208 and packaged into corresponding potions of initial training datasets 220 and/or validation datasets 234.

As described herein, the plurality of testing datasets 240 and ground-truth labels 216 may, when provisioned to, and ingested by, the nodes of the decision trees of the adaptively trained, and validated, gradient-boosted, decision-tree process (e.g., established in accordance with validated process data 236), enable executed training engine 202 to validate the predictive capability and accuracy of the adaptively trained, gradient-boosted, decision-tree process, for example, based on the elements of ground-truth labels 218 associated with corresponding ones of the testing datasets 240, and based on one or more computed metrics, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves.

Referring back to FIG. 2C, executed training input module 208 may provide the plurality of testing datasets 240 and corresponding ground-truth labels 218 as inputs to executed adaptive training module 228. In some instances, executed adaptive training module 228 may obtain validated process data 236 from pre-processed data store 143, and may perform operations that establish the plurality of nodes and the plurality of decision trees for the gradient-boosted, decision-tree process in accordance with each, or a subset, of validated process data 236. As described herein, validated process data 236 for the adaptively trained, and validated, gradient-boosted, decision-tree process may include, but are not limited to, a learning rate, a number of discrete decision trees (e.g., the “n_estimator” for the adaptively trained, gradient-boosted, decision-tree process), a tree depth characterizing a depth of each of the discrete decision trees, a minimum number of observations in terminal nodes of the decision trees, and/or values of one or more hyperparameters that reduce potential model overfitting (e.g., regularization of pseudo-regularization hyperparameters).

Executed adaptive training module 228 may perform any of the exemplary processes described herein to apply the adaptively trained, and validated, gradient-boosted, decision-tree process to the elements of the out-of-time testing data maintained within respective ones of testing datasets 240, e.g., based on an ingestion and processing of the data maintained within respective ones of testing datasets 240 by the established nodes and decision trees of the adaptively trained, gradient-boosted, decision-tree process. Further, executed adaptive training module 228 may also perform operations that generate elements of output data through the application of the adaptively trained, gradient-boosted, decision-tree process to corresponding ones of testing datasets 240. In some instances, each of elements of output data may include a predicted final decision on a pre-approval of a corresponding one of the applications for a home mortgage, HELOC, another real-estate secured lending product associated with each of testing datasets 240. As described herein, the final pre-approval decision may correspond to a positive decision (e.g., a decision to pre-approve the application) or a negative decision (e.g., a decision declining to pre-approve the application).

Executed adaptive training module 228 may also perform operations that compute a value of one or more metrics that characterize a predictive capability, and an accuracy, of the adaptively trained, and validated, gradient-boosted, decision-tree process based on the generated elements of output data, corresponding ones of testing datasets 240, and corresponding elements of ground-truth labels 218. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, a computed value of an AUC for a receiver operating characteristic (ROC) curve associated with the adaptively trained, gradient-boosted, decision-tree process, and additionally, or alternatively, a computed value of multiclass, one-versus-all area under curve (MAUC) for a ROC curve. The disclosed embodiments are, however, not limited to these exemplary computed metric values, and in other instances, executed adaptive training module 228 may compute a value of any additional, or alternate, metric appropriate to testing datasets 240, ground-truth labels 218, or the adaptively trained, and validated, gradient-boosted, decision-tree process.

In some examples, executed adaptive training module 228 may also perform operations that determine whether all, or a selected portion of, the computed metric values satisfy one or more threshold conditions for a deployment of the adaptively trained, and validated, gradient-boosted, decision-tree process and a real-time application to elements of application, customer profile, account, transaction, and credit-bureau data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values and/or MAUC values. In some examples, executed adaptive training module 228 that establish whether one, or more, of the computed recall-based values, the computed precision-based values, or the computed AUC or MAUC values exceed, or fall below, a corresponding one of the predetermined threshold values and as such, whether the adaptively trained, gradient-boosted, decision-tree process satisfies the one or more threshold requirements for deployment.

If, for example, executed adaptive training module 228 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of customer profile, account, transaction, credit-bureau, and/or application data described herein. Executed adaptive training module 228 may perform operations (not illustrated in FIG. 2C) that transmit data indicative of the established inaccuracy to executed training input module 208, which may perform any of the exemplary processes described herein to generate one or more additional training datasets and corresponding ground-truth labels, which may be provisioned to executed adaptive training module 228. In some instances, executed adaptive training module 228 may receive the additional training datasets and corresponding ground-truth labels, and may perform any of the exemplary processes described herein to train further the gradient-boosted, decision-tree process against the elements of training data included within each of the additional training datasets.

Alternatively, if executed adaptive training module 228 were to establish that each computed metric value satisfies threshold requirements, FI computing system 130 may deem the adaptively training, and validated, gradient-boosted, decision-tree process ready for deployment and real-time application to the elements of customer profile, account, transaction, credit-bureau, or application data described herein. In some instances, executed adaptive training module 228 may generate deployed process data 242 that includes the one or more process parameters of the adaptively trained, and validated, gradient-boosted, decision-tree process, such as, but not limited to, each of the process parameters specified within validated process data 236. Further, executed adaptive training module 228 may also generate deployed input data 244, which characterizes a composition of an input dataset for the adaptively trained, and validated, gradient-boosted, decision-tree process and identifies each of the discrete feature values within the input dataset, along with a sequence or position of these feature values within the input dataset. As illustrated in FIG. 2C, executed adaptive training module 228 may perform operations that store deployed process data 242 and deployed input data 244 within the one or more tangible, non-transitory memories of FI computing system 130, such as pre-processed data store 143.

### B. Exemplary Processes for Predicting Application Pre-Approval in Real-Time Using Trained Artificial Intelligence Processes

In some examples, one or more computing systems associated with or operated by a financial institution, such as one or more of the distributed components of FI computing system 130, may perform operations that adaptively train a machine learning or artificial intelligence process to predict an expected, final decision on pre-approval of an application for a home mortgage, a HELOC, or another RESL product involving one or more discrete applicants in real-time and on-demand upon receipt from a corresponding digital channel using training and validation datasets associated with an in-time temporal interval and using testing datasets associated with a distinct, out-of-time temporal interval. As described herein, the final decision may correspond to a positive decision (e.g., pre-approval) or a negative decision (e.g., denial). Further, the machine-learning or artificial-intelligence process may include an ensemble or decision-tree process, such as a gradient-boosted, decision-tree process, and the training, validation, and testing data may include, but are not limited to, elements of the application, customer profile, account, transaction, and/or credit-bureau data described herein.

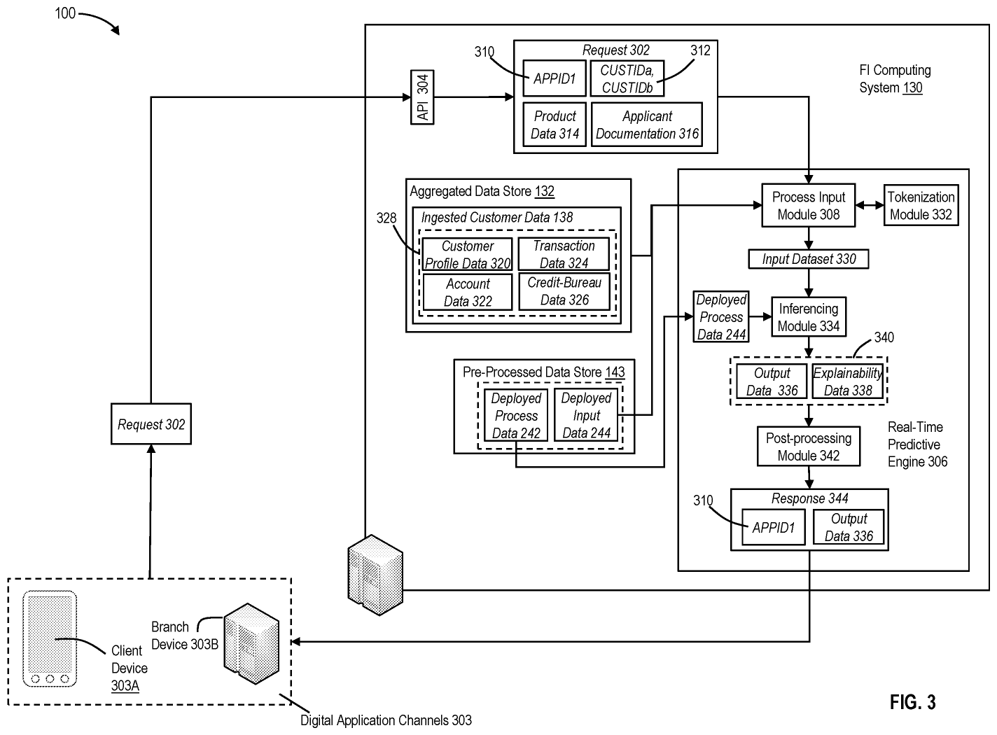

Referring to FIG. 3, a customer of a financial institution may elect to apply for a home mortgage, a HELOC, or another RESL product, and may initiate the application process by providing input to an application program executed by a corresponding client device 303A. In other examples, the customer may visit a physical branch of the financial institution, and may provide information to a representative of the financial institution, who may input the information into an application program executed at a branch device 303B. Client device 303A and additionally, or alternatively, branch device 303B (e.g., collectively referred to as digital application channels 303), may generate elements of a request 302 for an application for the home mortgage, HELOC, or other RESL product, and transmit the elements of request 302 across network 120 to FI computing system 130.

In some instances, client device 303A and branch device 303B may include a computing device having one or more tangible, non-transitory memories that store data and/or software instructions, and one or more configured to execute the software instructions. The one or more tangible, non-transitory memories may, in some aspects, store software applications, application modules, and other elements of code executable by the one or more processors, such as, but not limited to, an executable web browser (e.g., Google Chrome™, Apple Safari™, etc.) and an executable application associated with FI computing system 130 (e.g., a mobile banking application). Each of client device 303A and branch device 303B may also include a display unit configured to present interface elements to a corresponding user, and an input unit configured to receive input from the corresponding user, e.g., in response to the interface elements presented through the display unit. By way of example, the display unit may include, but is not limited to, an LCD display unit or other appropriate type of display unit, and the input unit may include, but is not limited to, a keypad, keyboard, touchscreen, voice activated control technologies, or appropriate type of input unit. In some instances, the functionalities of the display and input units may be combined into a single device, e.g., a pressure-sensitive touchscreen display unit that presents interface elements and receives input from the corresponding user. Each of client device 303A and branch device 303B may also include a communications interface, such as a wireless transceiver device, coupled to a corresponding processor and configured by that corresponding processor to establish and maintain communications with network 120 via one or more communication protocols, such as WiFi®, Bluetooth®, NFC, a cellular communications protocol (e.g., LTER, CDMA®, GSM®, etc.), or any other suitable communications protocol.

Examples of client device 303A and branch device 303B may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as the display unit. In some instances, client device 303A and branch device 303B may also establish communications with one or more additional computing systems or devices operating within environment 100 across a wired or wireless communications channel, e.g., via the corresponding communications interface using any appropriate communications protocol. Further, a corresponding user may operate client device 303A, or branch device 303B, and may do so to cause client device 303A and branch device 303B to perform one or more exemplary processes described herein.

Referring back to FIG. 3, a programmatic interface associated with a real-time predictive engine executed by FI computing system 130, such as application programming interface 304 of real-time predictive engine 306, may receive request 302, and route request 302 to a process input module 308 of executed real-time predictive engine 306. For example, as described herein, the customer may elect to apply for a thirty-year, fixed-rate, $1,000,000 home mortgage jointly with a partner, and request 302 may include an application identifier 310 (e.g., an alphanumeric identifier, such as “APPID1,” assigned by the application program executed by client device 303A or alternatively, by the branch device 303B) and identifiers 312 of the each of the applicants (e.g., unique, alphanumeric identifiers associated with the customer and the partner, such as “CUSTIDa” and “CUSTIDb,” which may be assigned by FI computing system 130 or by the application program executed by client device 303A or branch device 303B).

Further, as illustrated in FIG. 3, request 302 may also include elements of product data 314, which identify and characterize the thirty-year, fixed-rate, $1,000,000 home mortgage, and elements of applicant documentation 316, which include all, or a portion of, a submission of documentation that identifies and characterizes each of the applicants (e.g., the existing customer and the partner) and support the requested pre-approval of the application for the thirty-year, fixed-rate, $1,000,000 home mortgage. In some instances, the application program executed by client device 303A, or alternatively, by branch device 303B, may generate the elements of product data 314, and the elements of applicant documentation 316, based on input provided by the customer and/or the partner to a corresponding one of client device 303A or branch device 303B (e.g., via a corresponding display unit) and/or based on additional data characterizing the customer, the partner, and the interactions between the customer, the partner, and the financial institution (or other financial institution), which may be available to the application program executed by the corresponding one of client device 303A or branch device 303B.

As described herein, the elements of product data 314 may include, but are not limited to, a unique identifier of the home mortgage (e.g., a product name, a unique, alphanumeric identifier assigned to the product by FI computing system 130, etc.) and a value of one or more parameters of the home mortgage, such as the $1,000,000 loan amount, the thirty-year loan term, and information characterizing a fixed interest rate. Further, and as described herein, the elements of applicant documentation 316 may include, but are not limited to, a full name of each of the applicants (e.g., the full name of the customer and the partner, etc.), a unique governmental identifier assigned to each of the applicants by a governmental entity (e.g., a social-security number or a driver's license number of the customer and the partner, etc.), and information characterizing a parcel of real estate that servers as collateral for the home mortgage, such as an address, a digital copy of a deed or conveyance, a current assessment of the parcel, or one or more digital images of the parcel. The elements of applicant documentation 108 may also include, but are not limited to, information characterize a current residence and employment of the one or more applicants, information characterizing a current and temporal evolution of an income of the one or more applicants, information identifying a current value in, and a temporal evolution of, assets and liabilities held by the one or more applicants, information identifying a current value of, and a temporal evolution of, a credit score of the one or more applicants and/or information characterizing an employment or tax history of the one or more applicants.

As described herein, the received elements of request 302 may be encrypted, and executed process input module 308 may perform operations that decrypt each of the encrypted elements of request 302 using a corresponding decryption key (e.g., a private cryptographic key associated with FI computing system 130). Executed process input module 308 may also perform operations that sore the elements of request 302 within a corresponding portion of a tangible, non-transitory memory of FI computing system 130 (not illustrated in FIG. 3).

In some examples, executed real-time predictive engine 306 may perform any of the exemplary processes described herein to generate an input dataset associated with the application for the thirty-year, fixed-rate, $1,000,000 home mortgage characterized by request 302. Further, executed real-time predictive engine 306 may perform operations, described herein that based on an application of an adaptively trained, and validated, gradient-boosted, decision-tree process (e.g., the trained XGBoost process described herein) to the input dataset, generate an element output data indicative of an expected final decision on a pre-approval of the application for the thirty-year, fixed-rate, $1,000,000 home mortgage, and that provision a response to request 302 that includes the element of output data to a corresponding one of client device 303A or branch device 303B that generated request 302, e.g., for presentation within a corresponding display unit. In some instances, through an implementation of one or more of the exemplary processes described herein, executed real-time predictive engine 306 may generate and provision the response to request 302, which includes the elements of output data characterizing the expected final decision on the pre-approval of the application for the thirty-year, fixed-rate, $1,000,000 home mortgage, to a corresponding one of client device 303A or branch device 303B in real-time and contemporaneously with a generation and a receipt of request 302 (such as, but not limited to, within twenty seconds of the generation of request 302 by client device 303A or branch device 303B).

Referring back to FIG. 3, executed process input module 308 may perform operations that obtain, from pre-processed data store 143, elements of deployed input data 244 that characterize a composition of an input dataset for the adaptively trained, and validated, gradient-boosted, decision-tree process and identify each of the discrete feature values within the input dataset, along with a sequence or position of these feature values within the input dataset. By way of example, executed process input module 308 may perform operations, described herein, that obtain or extract one or more of the input features values specified within the elements of deployed input data 244 from corresponding portions of request 302, e.g., from portions of product data 314 or applicant documentation 316.

Executed process input module 308 may also perform operations, described herein, that obtain or extract additional, or alternative, ones of the input features values specified within the elements of deployed input data 244 from elements of previously ingested customer profile, account, transaction, or credit-bureau data that characterize each of the applicants involved in the application for the thirty-year, fixed-rate, $1,000,000 home mortgage, e.g., the customer and the partner. For example, executed process input module 308 may parse request 302 and obtain each of applicant identifiers 312 of the customer and the partner (e.g., “CUSTIDa” and “CUSTIDb”), and as illustrated in FIG. 3, executed process input module 308 may access ingested customer data 138 maintained within aggregated data store 132, and based on applicant identifiers 312, access and obtain elements of customer profile data 320, account data 322, transaction data 324, and credit bureau data 326 that characterize each of the applicants involved in the application for the thirty-year, fixed-rate, $1,000,000 home mortgage and the interactions of these applicants with the financial institution, and with other financial institutions and related entities.

The obtained elements of customer profile data 320, account data 322, transaction data 324, and credit bureau data 326 may, for example, include respective ones of the exemplary elements of customer profile data 110, account data 112, transaction data 114, and credit-bureau data 116 ingested by executed ingestion engine 136 (as described herein), and the obtained elements of customer profile data 320, account data 322, transaction data 324, and credit bureau data 326 may be characterized collectively as elements of interaction data 328. In some instances, executed process input module 308 may perform operations that obtain or extract additional, or alternative, ones of the input features values specified within the elements of deployed input data 244 from corresponding ones of the elements of customer profile data 320, account data 322, transaction data 324, and credit bureau data 326, e.g., in accordance with the elements of deployed input data 244.

Further, in some examples, executed process input module 308 may perform operations that compute, determine, or derive one or more of the features values based on elements of data extracted or obtained from the corresponding portions of request 302 (e.g., from portions of product data 314 or applicant documentation 316), and additionally, or alternatively, from the obtained elements of customer profile data 320, account data 322, transaction data 324, and credit bureau data 326 (e.g., the elements of interaction data 328). Examples of these obtained or extracted input feature values, and of these computed, determined, or derived input feature values, include, but are not limited to, one or more of the feature values extracted, obtained, computed, determined, or derived by executed training input module 208 and packaged into corresponding potions of initial training datasets 220, validation datasets 234, and testing datasets 240.

As illustrated in FIG. 3, executed process input module 308 may perform operations that package each of the obtained, extracted, computed, determined, or derived input feature values into corresponding portions of input dataset 330 in accordance with the respective sequences or positions specified within the elements of deployed input data 244. In some examples, and prior to computing, determining, or deriving certain of the input feature values based on the data extracted or obtained from the corresponding portions of request 302 or from the obtained elements customer profile data 320, account data 322, transaction data 324, and credit bureau data 326, and prior to packaging any of the obtained or extracted input feature values into corresponding portions of input dataset 330, a tokenization module 332 of executed real-time predictive engine 306 may perform any of the exemplary processes described herein to tokenize of or obfuscate elements of sensitive or confidential data within the input feature values obtained or extracted from the corresponding portions of request 302 (e.g., from portions of product data 314 or applicant documentation 316) and additionally, or alternatively, to tokenize or obfuscate sensitive or confidential data within the obtained elements customer profile data 320, account data 322, transaction data 324, and credit bureau data 326.

Executed process input module 308 may perform any of the exemplary processes described herein to compute, determine, or derive the one or more of the features values based on the tokenized elements of data extracted or obtained from the corresponding portions of request 302 (e.g., from portions of product data 314 or applicant documentation 316), and additionally, or alternatively, based on the tokenized elements of customer profile data 320, account data 322, transaction data 324, and credit bureau data 326 that associated with each of the applicants. In some instances, executed process input module 308 may perform operations that package the obtained or extracted input feature values (e.g., as tokenized using any of the exemplary processes described herein) and the computed, determined, or derived input feature values (e.g., as computed, determined, or derived from the elements of tokenized data described herein) into corresponding portions of input dataset 330 in accordance with the respective sequences or positions specified within the elements of deployed input data 244.

An inferencing module 334 of executed real-time predictive engine 306 may perform operations that obtain, from pre-processed data store 143, elements of deployed process data 242 that includes one or more process parameters of the adaptively trained, gradient-boosted, decision-tree process. For example, and as described herein, the process parameters included within deployed process data 242 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some instances, and based on portions of deployed process data 242, executed inferencing module 334 may perform operations that establish a plurality of nodes and a plurality of decision trees for the adaptively trained, gradient-boosted, decision-tree process, each of which receive, as inputs, corresponding elements of input dataset 330 (e.g., to “ingest” the corresponding elements of input dataset 330). Further, and based on the execution of inferencing module 334, and on the ingestion of input dataset 330 by the established nodes and decision trees of the adaptively trained, gradient-boosted, decision-tree process, FI computing system 130 may perform operations that apply the adaptively trained, gradient-boosted, decision-tree process to input dataset 330, and that generate elements of output data 336 indicative of the expected final decision on a pre-approval of application for the home mortgage associated with request 302 (e.g., the application for the thirty-year, fixed-rate, $1,000,000 home mortgage involving the customer of the financial institution and the partner) and elements of explainability data 338 that characterize a relative importance of one or more of the input feature values included input dataset 330.

For example, the elements of output data 336 may include a binary, numerical output indicative of the predicted final decision on pre-approval of the application for the home mortgage associated with request 302 (e.g., with a value of unity being indicative of a predicted pre-approval of the application, and with a value of zero being indicative of a predicted denial of the application), and additionally, or alternatively, may include an alphanumeric character string indicative of the predicted pre-approval of the application (e.g., “PRE-APPROVED”) or the predicted denial of the application (e.g., “DENIED”). Further, in some instances, the elements of explainability data 338 may include, among other things, one or more Shapley values that characterize an average marginal contribution of corresponding ones of the input feature values to the predicted final decision on pre-approval of the application for the home mortgage associated with request 302.

Additionally, or alternatively, the elements of explainability data 338 may also include values of probabilistic metrics that average a computed area under curve for receiver operating characteristic (ROC) curves for the binary classification, or other metrics that would characterize the relative importance of one or more of the input feature values included within input dataset 330 and that would be appropriate to the feature values within input dataset 330 or to the adaptively trained, gradient-boosted decision-tree process. As illustrated in FIG. 3, executed inferencing module 334 may package into the elements of output data 336 and the elements of explainability data into corresponding portions of predictive output 340, which executed inferencing module 334 may provision as an input to a post-processing module 342 of executed real-time predictive engine 306, either individually or in conjunction with input dataset 330.

In some instances, and upon receipt of predictive output 340 (e.g., and additionally, or alternatively, of input dataset 330), executed post-processing module 342 may perform operations that obtain application identifier 310 from request 302 (e.g., “APPID1”), and that package application identifier 310 and the elements of output data 336, which indicates the predicted, final decision on a pre-approval of application for the home mortgage associated with request 302, into corresponding portions of a response 344 to request 302. As illustrated in FIG. 3, executed real-time predictive engine 306 may cause FI computing system 130 may perform operations that transmit all, or a selected portion of, response 344 across network 120 to a corresponding one of digital application channels 303 that initiated the application for the home mortgage and that generated request 302, e.g., one of client device 303A and branch device 303B. In some examples, the application program executed by client device 303A, or by branch device 303B, may process response 344 and present a graphical representation of the elements of output data 336, and the predicted, final decision on a pre-approval of the application for the home mortgage, within a corresponding digital interface, and the customer may obtain the decision on pre-approval in real-time and contemporaneously with the submission of the application (e.g., such as, but not limited to, within approximately twenty seconds of the generation of request 302 by the application executed by the corresponding one of client device 303A, or by branch device 303B).

By way of example, the application program executed by client device 303A may generate request 302 based on input data received via the corresponding input unit from the customer, e.g., one of the two individual applicants involved in the application for the thirty-year, fixed-rate, $1,000,000 home mortgage. Further, upon receipt of response 344 at client device 303A, the executed application program may process application identifier 310 and perform operations that generate and present, within a corresponding digital interface via the display unit, elements of digital content that confirm, to the customer, the pre-approved status of the application for the thirty-year, fixed-rate, $1,000,000 home mortgage involving the customer and the partner. In some instances, and based on the pre-approved status of the application, the executed application program may also perform operations that obtains additional data (e.g., via FI computing system 130 across network 120) identifying one or more outstanding requirements associated with a completion of the underwriting process for the application for the thirty-year, fixed-rate, $1,000,000 home mortgage.

In some instances, the executed application program may cause client device 303A to present, within the corresponding digital interface via the display unit, additional elements of digital content that characterize each of the one or more outstanding requirements, and that prompt the customer (and/or the co-applicant, the partner) to provide additional information satisfying all, or a selected portion, of the outstanding requirements to client device 303A via the corresponding input unit. The executed application program may, for example, cause client device 303A to transmit the additional information across network 120 to FI computing system 130. Alternatively, the additional, presented elements of digital content may prompt the customer (and/or the co-applicant, the partner) to visit a physical branch location of the financial institution and provision all, or a selected portion, of the additional information to the representative of the financial institution, which branch device 303B operable by the representative may transmit the additional informational information across network 120 to FI computing system 130. Upon satisfaction of the outstanding requirements associated with the pre-approved application for the thirty-year, fixed-rate, $1,000,000 home mortgage, and upon completion of the underwriting requirements, the financial institution may issue the thirty-year, fixed-rate, $1,000,000 home mortgage to the customer and the partner.

Alternatively although not described in FIG. 3, if the elements of output data 336 included within response 344 were to indicate a denial of the request to pre-approve the application for the thirty-year, fixed-rate, $1,000,000, the application program executed by client device 303A may process application identifier 310 and perform operations that generate and present, within a corresponding digital interface via the display unit, elements of digital content that confirm, to the customer, the denied status of the application for the thirty-year, fixed-rate, $1,000,000 home mortgage involving the customer and the partner. In some instances, and based on the denied status of the application, the executed application program may also perform operations that obtains further data (e.g., via FI computing system 130 across network 120) identifying one or more deficiencies in the denied application for the thirty-year, fixed-rate, $1,000,000 home mortgage.

The executed application program may cause client device 303A to present, within the corresponding digital interface via the display unit, further elements of digital content that identify and characterize each of the one or more deficiencies in the denied application for the thirty-year, fixed-rate, $1,000,000 home mortgage, and that prompt the customer (and/or the co-applicant, the partner) to obtain additional applicant documentation that address all, or at least a subset of, these deficiencies. Further, the presented further elements of digital content may also prompt the customer (and/or the co-applicant, the partner) to submit the additional applicant documentation to FI computing system 130 via the application program executed at client device 303A (e.g., based on input provided by the corresponding input unit) and/or through the representative of the financial institution via the application program executed by branch device 303B, e.g., as an intermediate submission associated with application identifier 310 of the denied application for the thirty-year, fixed-rate, $1,000,000 home mortgage. Upon receipt of the additional applicant documentation within a portion of an additional request, FI computing system 130 may perform any of the exemplary processes described herein to predict an expected, final decision on pre-approval of application for the thirty-year, fixed-rate, $1,000,000 home mortgage based on the intermediate submission and the additional applicant documentation.

As described herein, one or more computing systems associated with or operated by a financial institution, such as one or more of the distributed components of FI computing system 130, may perform operations that, based on an application of an adaptively trained artificial intelligence process to a corresponding input data set, predict an expected, final decision on pre-approval of an application for a home mortgage, a HELOC, or another RESL product involving one or more discrete applicants in real-time and on-demand upon receipt from a corresponding digital channel. While these exemplary processes may eliminate a manual examination of a corresponding application by an underwriter, these exemplary processes may also replace those processes that apply a corresponding underwriter label (e.g., indicative of a final decision on pre-approval, as described herein) to corresponding elements of application data, which may renders difficult an establishment of ground-truth labelling for future monitoring and re-training of the adaptively trained, gradient-boosted decision-tree process.

In some examples, to address an ongoing monitoring and re-training of the adaptively trained, gradient-boosted decision-tree process, certain of the exemplary processes described herein may route a pre-determined portion of applications received from digital application channels 303 (e.g., a predetermined percentage, such as 1.0%, 1.5%, 2%, or a range of percentages between 1.0% and 2.0%, etc.) to a computing device or a computing system operable by underwriter, e.g., for manual pre-approval processing. These exemplary processes may, for example, provide a “control population” that facilitates monitoring and re-training of the adaptively trained, gradient-boosted decision-tree process, which may enable compliance processing by FI computing system 130. Further, facing changes in underwriting policies for certain applications or certain applicants, certain of the exemplary processes described herein may assign, to an incoming application, a binary flag that, if set to unity, causes API 304 or real-time predictive engine 306 to routes these applications to an underwriter for conventional processing.

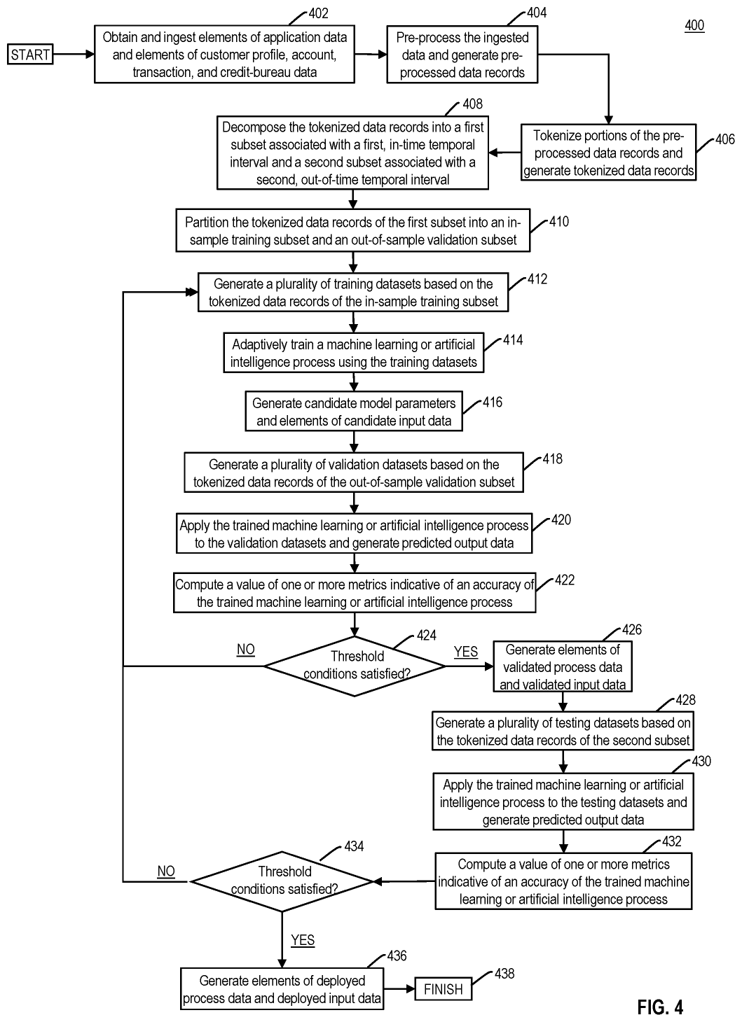

FIG. 4 is a flowchart of an exemplary process 400 for adaptively training a machine-learning or artificial-intelligence process to predict an expected, final decision on pre-approval of an application for a home mortgage, a HELOC, or another RESL product involving one or more discrete applicants in real-time and on-demand upon receipt from a corresponding digital channel, in accordance with some exemplary embodiments. The predicted final decision may, for example, correspond to predicted pre-approval of the application (e.g., a positive decision) or alternatively, to a predicted denial of the application (e.g., a negative decision). Further, in some instances, the machine-learning or artificial-intelligence process may include an ensemble or decision-tree process, such as a gradient-boosted decision-tree process (e.g., the XGBoost process), and one or more of the exemplary, adaptive training processes described herein may utilize partitioned training and validations datasets associated with a first prior temporal interval (e.g., an in-time training and validation interval), and testing datasets associated with a second, and distinct, prior temporal interval (e.g., an out-of-time testing interval). As described herein, one or more computing systems, such as, but not limited to, one or more of the distributed components of FI computing system 130, may perform one or of the steps of exemplary process 300.

Referring to FIG. 4, FI computing system 130 may establish a secure, programmatic channel of communication with one or more source computing systems, such as source systems 102 of FIG. 1, and may perform operations that obtain, from the source computing systems, elements of application data that identify or characterize one or more applications for home mortgages, HELOCs, and other RESL products initiated by, or involving, one or more corresponding applicants during one or more temporal intervals (e.g., in step 402 of FIG. 4). As described herein, the obtained elements of application data may include, for each of the applications for the home mortgages, HELOCs, and other RESL products, a corresponding alphanumeric application identifier, decision data characterizing a final decision on a pre-approval of the corresponding application (e.g., pre-approve or decline, etc.), and temporal data identifying a time or date of the final decision, e.g., by an underwriter. Further, and for each of the applications for the home mortgages, HELOCs, and other RESL products, the obtained elements of application data may also include corresponding elements of product data, which identify and characterize the home mortgage, HELOC, or other RESL product associated with the corresponding application, and elements of applicant documentation that include portions of a final submission of documentation supporting the final decision on the pre-approval of the corresponding application (and in some instances, portions of an initial and one or more intermediate submissions).

FI computing system 130 may also perform operations that obtain, from the source computing systems, elements of customer profile, account, and transaction data that that identify and characterize one or more customers of the financial institution during the one or more temporal intervals, and elements of credit-bureau data that characterize one or more customers of the financial institution (and in some instances, prospective customers of the financial institution) during the one or more temporal intervals (e.g., also in step 402 of FIG. 4). FI computing system 130 may also perform operations, such as those described herein, that store (or ingest) the obtained elements of application, customer profile, account, transaction and credit-bureau data within one or more accessible data repositories, such as aggregated data store 132, in conjunction with temporal data characterizing corresponding ingestion dates (e.g., also in step 402 of FIG. 4). In some instances, FI computing system 130 may perform the exemplary processes described herein to obtain and ingest the elements of application, customer profile, account, transaction and credit-bureau data in accordance with a predetermined temporal schedule (e.g., on a monthly basis at a predetermined date or time, etc.), or a continuous streaming basis, across the secure, programmatic channel of communication.

In some instances, FI computing system 130 may access the ingested elements of application data, including the corresponding application identifiers, elements of decision data and temporal data, elements of product data and the elements of applicant documentation, and may perform one or more of the exemplary processes described herein to aggregate, filter, and process selectively the accessed elements of application data and generate one or more pre-processed data records that characterize corresponding ones of the applications for the home mortgages, HELOCs, and other RESL products, each of the one or more applicants involved in the corresponding ones of the applications, and the final decisions on pre-approval for the corresponding ones of the applications (e.g., in step 404 in FIG. 4). As described herein, FI computing system 130 may store each of the pre-processed data records within one or more accessible data repositories, such as pre-processed data store 143 (e.g., also in step 404 of FIG. 4).

FI computing system 130 may also perform any of the exemplary processes described herein to tokenize or obfuscate selectively portions of the pre-processed data records that characterize corresponding ones of the applications for the home mortgages, HELOCs, and other RESL products, each of the one or more applicants involved in the corresponding ones of the applications, and the final decisions on pre-approval for the corresponding ones of the applications (e.g., in step 406 of FIG. 4). As described herein, FI computing system 130 may store each of the tokenized (or obfuscated) data records within one or more the accessible data repositories, such as within pre-processed data store 143 (e.g., also in step 406 of FIG. 4).

As described herein, each of the tokenized data records may characterize corresponding ones of the applications for the home mortgages, HELOCs, and other RESL products, and each of the tokenized data records may specify the date of associated with the final decision (e.g., a “final decision date”) on pre-approval rendered by the underwriter for the corresponding one of the applications. In some instances, and based on the final decision dates specified by the tokenized data records, FI computing system 130 may perform any of the exemplary processes described herein to decompose the tokenized data records into (i) a first subset of the tokenized data records that are associated with applications having final decisions dates disposed within a first prior temporal interval (e.g., the in-time training and validation interval Δt_{train/validate}, as described herein) and (ii) a second subset of the tokenized data records that are associated with applications having final decisions dates disposed within a second prior temporal interval (e.g., the out-of-time testing interval Δt_{testing}, as described herein), which may be separate, distinct, and disjoint from the first prior temporal interval (e.g., in step 408 of FIG. 4).

Further, in some instances, FI computing system 130 may also perform any of the exemplary processes described herein to partition the tokenized data records of within the first subset into (i) an in-sample training subset of tokenized data records appropriate to train adaptively the machine-learning or artificial process (e.g., the gradient-boosted decision process described herein) during the first prior temporal interval and (ii) an out-of-sample validation subset of the tokenized data records appropriate to validate the adaptively trained gradient-boosted decision process during the first prior temporal interval (e.g., in step 410 of FIG. 4). Additionally, and as described herein, the second subset of the tokenized data records may be appropriate to test an accuracy or a performance of the adaptively trained gradient-boosted decision process using elements of testing data associated with the second temporal interval, e.g., the out-of-time testing interval Δt_{testing}. FI computing system 130 may also perform any of the exemplary processes described herein to a ground-truth label associated with each of the tokenized data records maintained within corresponding ones of the in-sample training subset and out-of-sample validation subset of the first subset (e.g., also in step 410 of FIG. 4), and to generate information characterizing a ground-truth label associated with each of the tokenized data records maintained within and the second subset (e.g., in step 408 of FIG. 4).

In some instances, FI computing system 130 may perform any of the exemplary processes described herein to generate one or more initial training datasets based on data maintained within the tokenized data records associated with the in-time training subset, and additionally, or alternatively, based on elements of ingested customer profile, account, transaction, or credit-bureau data associated with the applications (and applicants) characterized by corresponding ones of the tokenized data records (e.g., in step 412 of FIG. 4). As described herein, each of the plurality of initial training datasets may be associated with a corresponding one of the applications for the home mortgage, HELOC, or other RESL products, which may be characterized by a corresponding one of the tokenized data records of the in-sample training subset, and which are associated with a final decision date disposed within the first prior temporal interval (e.g., the in-time training and validation interval Δt_{train/validate}, as described herein)

In some instances, each of the of initial training datasets may include an application identifier associated with the corresponding application (e.g., application identifier 144 of FIG. 1), an applicant identifier associated with each of the applicants involved in the corresponding application (e.g., applicant identifiers 146 of FIG. 1), and temporal data specifying the final decision date rendered by the underwriter in the corresponding application (e.g., temporal data 150 of FIG. 1). Further, each of the plurality of initial training datasets 220 may also include elements of data (e.g., feature values) that characterize the application for the home mortgage, HELOC, or other RESL product and additionally, or alternatively, each or a subset of the applicants involved in the application. Each of the initial training datasets may also be associated with a corresponding application-specific ground-truth label, which associates the corresponding one of initial training datasets with a positive target (e.g., indicative of an application pre-approved by the underwriter) or a negative target (e.g., indicative of an application declined by the underwriter).

Based on the plurality of training datasets, FI computing system 130 may also perform any of the exemplary processes described herein to train adaptively the machine-learning or artificial-intelligence process (e.g., the gradient-boosted decision-tree process described herein) to predict an expected final decision regarding a pre-approval of an application for a home mortgage, a HELOC, or another RESL product in real-time and on-demand upon receipt from a corresponding digital channel (e.g., in step 414 of FIG. 4). For example, and as described herein, FI computing system 130 may perform operations that establish a plurality of nodes and a plurality of decision trees for the gradient-boosted, decision-tree process, which may ingest and process the elements of training data maintained within each of the initial training datasets, and that train adaptively the gradient-boosted, decision-tree process against the elements of training data included within each of the initial training datasets.

Through the performance of these adaptive training processes, FI computing system 130 and may perform operations, described herein, that compute one or more candidate process parameters that characterize the adaptively trained, gradient-boosted, decision-tree process, and to generate elements of trained process data that include the candidate process parameters, such as, but not limited to, those described herein (e.g., in step 416 of FIG. 4). Further, and based on the performance of these adaptive training processes, FI computing system 130 may perform any of the exemplary processes described herein to generate trained input data, which specifies a candidate composition and sequence of feature values of an input dataset for the adaptively trained machine-learning or artificial intelligence process, such as the adaptively trained, gradient-boosted, decision-tree process (e.g., also in step 416 of FIG. 4).

In some instances, FI computing system 130 may also perform any of the exemplary processes described herein to, based on the elements of trained input data and trained process data, validate the trained gradient-boosted, decision-tree process against elements of in-time, but out-of-sample, data maintained within the tokenized data records of the out-of-time validation subset. For example, FI computing system 130 may perform any of the exemplary processes described herein generate a plurality of validation datasets based on tokenized data records of the out-of-time validation subset, and in some instances, based on temporally relevant elements of previously ingested customer profile, account, transaction, or credit-bureau data that characterize one or more applicants involved in the applications for the home mortgages, HELOCs, or other RESL products associated with corresponding ones of the tokenized data records (e.g., in step 418 of FIG. 4). As described herein, a composition, and a sequential ordering, of features values within each of validation datasets may be consistent with the composition and corresponding sequential ordering set forth in the trained input data, and each of validation datasets may be associated with a corresponding ground-truth label, which may be indicative of the final decision on pre-approval rendered by the underwriter in the corresponding one of the applications (e.g., a positive target associated with a pre-approved application, or a negative target associated with a declined the application).

FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets in accordance with the candidate process parameters, and to generate corresponding elements of output data based on the application of the adaptively trained machine-learning or artificial intelligence process to the respective ones of the validation datasets (e.g., in step 420 of FIG. 4). In some instances, each of elements of output data may include a predicted final decision on a pre-approval of a corresponding application for a home mortgage, HELOC, another real-estate secured lending product associated with a corresponding one of the validation datasets.

In some instances, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data, corresponding ones of the validation datasets, and the respective ground-truth labels (e.g., in step 422 of FIG. 4), and to determine whether all, or a selected portion of, the computed metric values satisfy one or more threshold requirements for a validation of the adaptively trained machine-learning or artificial intelligence process, such as those described herein (e.g., in step 426 of FIG. 4).

If, for example, FI computing system 130 were to establish that one, or more, of the computed metric values fail to satisfy at least one of the threshold requirements (e.g., step 424; NO), FI computing system 130 may establish that the adaptively trained, gradient-boosted, decision-tree process is insufficiently accurate for deployment and a real-time application to the elements of customer profile, account, transaction, credit-bureau, and/or application data described herein (e.g., step 424; NO). Exemplary process 400 may, for example, pass back to step 412, and FI computing system 130 may perform any of the exemplary processes described herein to generate additional training datasets based on the tokenized data records maintained within the in-time raining subset.

Alternatively, if FI computing system 130 were to establish that each computed metric value satisfies threshold requirements (e.g., step 424; YES), FI computing system 130 may validate the adaptive training of the gradient-boosted, decision-tree process, and may generate validated process data that includes the one or more validated process parameters of the adaptively trained, gradient-boosted, decision-tree process (e.g., in step 426 of FIG. 4) Further, FI computing system 130 may also generate validated input data, which characterizes a composition of an input dataset for the adaptively trained, and now validated, gradient-boosted, decision-tree process and identifies each of the discrete feature values within the input dataset, along with a sequence or position of these feature values within the input dataset (e.g., also in step 426 of FIG. 4). As described herein, FI computing system 130 may also perform operations that store the validated process data and the validated input data within the one or more tangible, non-transitory memories of FI computing system 130 (e.g., also in step 426 of FIG. 4).

Further, in some examples, FI computing system 130 may perform operations that further characterize an accuracy, and a performance, of the adaptively trained, and now-validated, gradient-boosted, decision-tree process against elements of testing data associated with the during the second temporal interval (e.g., the out-of-time testing interval Δt_{testing} described herein) and maintained within the tokenized data records of the second subset. As described herein, the further testing of the adaptively trained, and now-validated, gradient-boosted, decision-tree process against the elements of temporally distinct testing data may confirm a capability of the adaptively trained and validated, gradient-boosted, decision-tree process to predict an expected, final decision on a pre-approval of an application for a home mortgage, HELOC, or other real-estate secured lending product initiated by one or more applicants within a market environment that potentially differs from that characterizing the in-time testing and validation interval, and may further establish the readiness of the adaptively trained and validated, gradient-boosted, decision-tree process for deployment and real-time application to the elements of customer profile, account, transaction, credit-bureau, or application data.

Referring back to FIG. 4, FI computing system 130 may perform any of the exemplary processes described herein generate a plurality of testing datasets based on tokenized data records of the second subset, and in some instances, based on temporally relevant elements of previously ingested customer profile, account, transaction, or credit-bureau data that characterize one or more applicants involved in the applications for the home mortgages, HELOCs, or other real-estate secured lending products associated with corresponding ones of the tokenized data records (e.g., in step 428 of FIG. 4). As described herein, a composition, and a sequential ordering, of features values within each of testing datasets may be consistent with the composition and corresponding sequential ordering set forth in the validated input data, and each of the testing datasets may be associated with a corresponding ground-truth label, which may be indicative of the final decision on pre-approval rendered by the underwriter in the corresponding one of the applications (e.g., a positive target associated with a pre-approved application, or a negative target associated with a declined the application).

FI computing system 130 may perform any of the exemplary processes described herein to apply the adaptively trained machine-learning or artificial intelligence process (e.g., the adaptively trained, gradient-boosted, decision-tree process described herein) to respective ones of the testing datasets in accordance with the validated process parameters, and to generate corresponding elements of output data based on the application of the adaptively trained machine-learning or artificial intelligence process to the respective ones of the testing datasets (e.g., in step 430 of FIG. 4). For example, FI computing system 130 may perform operations, described herein, to establish the plurality of nodes and the plurality of decision trees for the gradient-boosted, decision-tree process in accordance with each, or a subset, of the validated process parameters, as described herein.

In some instances, in step 430 of FIG. 4, FI computing system 130 may perform any of the exemplary processes described herein to apply the adaptively trained, and validated, gradient-boosted, decision-tree process to the elements of the out-of-time data maintained within respective ones of the testing datasets, e.g., based on an ingestion and processing of the data maintained within respective ones of the testing datasets by the established nodes and decision trees of the adaptively trained, gradient-boosted, decision-tree process. Further, FI computing system 130 may also perform operations, described herein, that generate elements of output data through the application of the adaptively trained, gradient-boosted, decision-tree process to corresponding ones of the testing datasets (e.g., also in 430 of FIG. 4). In some instances, each of elements of output data may include a predicted final decision on a pre-approval of a corresponding one of the applications for a home mortgage, HELOC, another RESL product associated with each of the testing datasets.

FI computing system 130 may also perform any of the exemplary processes described herein to compute a value of one or more additional metrics that characterize a predictive capability, and an accuracy, of the adaptively trained, and validated, gradient-boosted, decision-tree process based on the generated elements of output data, corresponding ones of the testing datasets, and corresponding ones of the ground-truth labels (e.g., in step 432 of FIG. 4), and to determine whether all, or a selected portion of, the computed additional metric values satisfy one or more additional threshold requirements for a deployment of the adaptively trained machine-learning or artificial intelligence process, such as those described herein (e.g., in step 434 of FIG. 4).

In some examples, the threshold condition applied by FI computing system 130 to establish the readiness of the adaptively trained machine-learning or artificial intelligence process for deployment (e.g., in step 434) may be equivalent to those threshold conditions applied by FI computing system 130 to validate the adaptively trained machine-learning or artificial intelligence process. In other instances, the threshold conditions, or a magnitude of one or more of the threshold conditions, applied by FI computing system 130 may differ between the establishment of the readiness of the adaptively trained machine-learning or artificial intelligence process for deployment in step 434 and the validation of the adaptively trained machine-learning or artificial intelligence process in step 424.

If, for example, FI computing system 130 were to establish that one, or more, of the computed additional metric values fail to satisfy at least one of the threshold requirements (e.g., step 434; NO), FI computing system 130 may establish that the adaptively trained machine-learning or artificial-intelligence process (e.g., the adaptively trained, gradient-boosted, decision-tree process) is insufficiently accurate for deployment and real-time application to the elements of customer profile, account, transaction, insolvency, or credit-bureau data described herein. Exemplary process 400 may, for example, pass back to step 412, and FI computing system 130 may perform any of the exemplary processes described herein to generate additional training datasets based on the elements of the tokenized data records maintained within the in-time training subset.

Alternatively, if FI computing system 130 were to establish that each computed additional metric value satisfies threshold requirements (e.g., step 434; YES), FI computing system 130 may deem the machine-learning or artificial intelligence process (e.g., the gradient-boosted, decision-tree process described herein) adaptively trained and ready for deployment and real-time application to the elements of customer profile, account, transaction, credit performance, or credit-bureau data, and may perform any of the exemplary processes described herein to generate deployed process data that includes the validated process parameters and deployed input data associated with the of the adaptively trained machine-learning or artificial intelligence process (e.g., in step 436 of FIG. 4). Exemplary process 400 is then complete in step 438.

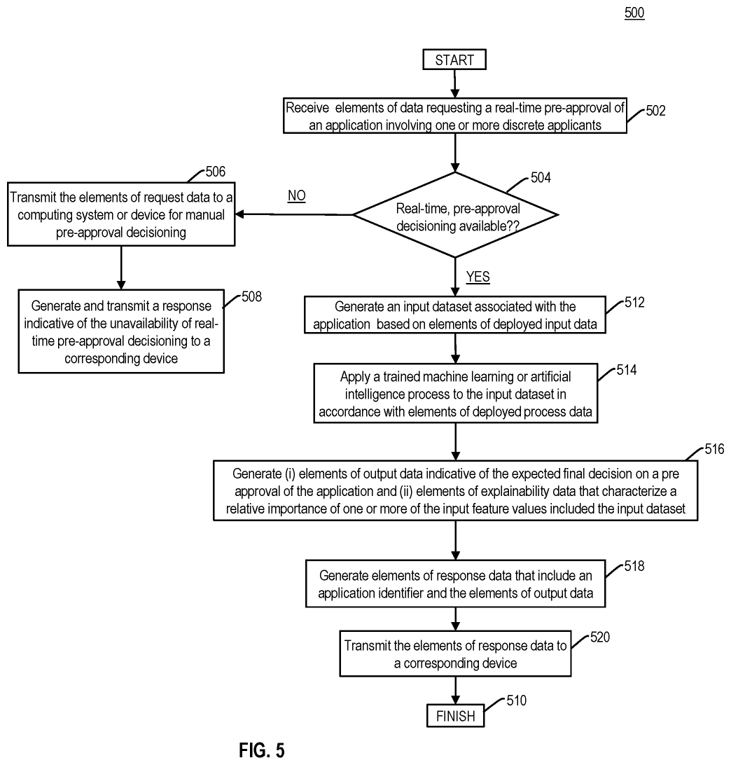

FIG. 5 is a flowchart of an exemplary process 500 for predicting an expected, final decision on pre-approval of an application for a home mortgage, a HELOC, or another real-estate secured lending (RESL) product involving one or more discrete applicants in real-time using a trained machine learning or artificial-intelligence processes. As described herein, the final decision may correspond to a positive decision (e.g., a pre-approved application) or a negative decision (e.g., denial), the machine-learning or artificial-intelligence process may include an ensemble or decision-tree process, such as a gradient-boosted, decision-tree process. In some instances, one or more computing systems, such as, but not limited to, one or more of the distributed components of FI computing system 130, may perform one or of the steps of exemplary process 500, as described herein.

Referring to FIG. 5, FI computing system 130 may perform any of the exemplary processes described herein to receive elements of data requesting a real-time pre-approval of an application for a home mortgage, HELOC, or other RESL product involving one or more discrete applicants (e.g., in step 502 of FIG. 5). As described herein, FI computing system 130 may receive the elements of request data from a computing system or device associated with a corresponding digital channel, such as, but not limited to, client device 303A of FIG. 3, which may be operable by one of the applicants, or branch device 303B of FIG. 3, which may be operable by a representative of the financial institution. Further, and as described herein, an application program executed by client device 303A, or alternatively, by branch device 303B, may generate the elements of request data and cause a corresponding one of the client device 303A or branch device 303B to transmit the elements of request data across network 120 to FI computing system 130. In some instances, FI computing system 130 may perform operations that store the received elements of request data within the one or more tangible memories of FI computing system 130 (e.g., also in step 502 of FIG. 5).

By way of example, the elements of request data may include, but are not limited to, a unique, alphanumeric identifier of the application for the home mortgage, HELOC, or other RESL product and a unique identifier of each of the one or more applicants involved in the application (e.g., a unique, alphanumeric identifier, etc.). Further, in some instances, the elements of request data may also include elements of product data that identify and characterize the home mortgage, HELOC, or other RESL product associated with the application, and elements of applicant documentation that identify and characterize each of the one or more applicants and that support the requested pre-approval of the application.

As described herein, the elements of product data may include, but are not limited to, a unique identifier of the home mortgage (e.g., a product name, a unique, alphanumeric identifier assigned to the product by FI computing system 130, etc.) and a value of one or more parameters of the home mortgage, such as a loan amount, a loan term, and information characterizing a fixed or variable interest rate. Further, and as described herein, the elements of applicant documentation may include, but are not limited to, a full name of each of the applicants involved in the application, a unique governmental identifier assigned to each of the applicants by a governmental entity (e.g., a social-security number or a driver's license number, etc.), and information characterizing a parcel of real estate that servers as collateral for the home mortgage, HELOC, or other RESL product, such as an address, a digital copy of a deed or conveyance, or a current assessment of the parcel by a governmental entity, or one or more digital images of the parcel. Additionally, in some instances, the elements of applicant documentation may also include, but are not limited to, information characterizing a current residence and employment of the one or more applicants, information characterizing a current and temporal evolution of an income of the one or more applicants, information identifying a current value in, and a temporal evolution of, assets and liabilities held by the one or more applicants, information identifying a current value of, and a temporal evolution of, a credit score of the one or more applicants and/or information characterizing an employment or tax history of the one or more applicants.

In some instances, FI computing system 130 may parse the elements of request data, including the elements of product data and applicant documentation, and based on the parsed elements of determine whether real-time, pre-approval decisioning is available to the application for the home mortgage, HELOC, or other RESL product (e.g., in step 504 of FIG. 4). By way of example, FI computing system 130 may subject certain applications home mortgages, HELOCs, or other RESL products to manual pre-approval decisioning by representatives of the financial institution (e.g., one or more of the underwriters described herein) in order to generate additional elements of labelled training, validation, and/or testing data associated with an ongoing monitoring of the trained machine learning or artificial intelligence process and additionally, or alternatively, further adaptive training of the trained machine learning or artificial intelligence process (e.g., based on the ongoing monitoring). Further, in some examples, FI computing system 130 may establish that a prior training, validation, or testing of the machine learning or artificial intelligence process fails to reflect an update or change in an internal policy affecting the pre-approval of applications for certain home mortgages, HELOCs, or other RESL products, and prior to further adaptive training of the trained machine learning or artificial intelligence process, which would reflect the update or change in the internal policy, FI computing system 130 may subject applications for these certain home mortgages, HELOCs, or other RESL products to manual pre-approval decisioning by representatives of the financial institution (e.g., one or more of the underwriters described herein).

If, for example, FI computing system 130 may determine that real-time, pre-approval decisioning is not available to the application for the home mortgage, HELOC, or other RESL product (e.g., step 504; NO), FI computing system 130 may perform operations that transmit all, or a selected portion, of the received elements of request data to an additional computing device or computing system operable by a representative of the financial institution (e.g., the underwriter), which may manually determine whether to pre-approve or decline the application based on, among other things, the elements of product data and applicant documentation (e.g., in step 506). FI computing system 130 may also perform operations that generate and transmit, to a corresponding one of client device 303A or branch device 303B, a response indicative of the unavailability of real-time, pre-approval decisioning for the application for the home mortgage, HELOC, or other RESL product (e.g., in step 508). As described herein, an application program executed by the corresponding one of client device 303A or branch device 303B may receive and process the transmitted response, and may perform operations that cause the corresponding one of client device 303A or branch device 303B to present digital content characterizing the unavailability of real-time, pre-approval decisioning for the application within a digital interface. Exemplary process 500 is then complete in step 510.

Alternatively, if FI computing system 130 were to establish that real-time, pre-approval decisioning is available to the application for the home mortgage, HELOC, or other RESL product (e.g., step 504; YES), FI computing system 130 may perform any of the exemplary processes described herein to generate an input dataset associated with the application for the home mortgage, HELOC, or other RESL product characterized by the received elements of request data (e.g., in step 512 of FIG. 5). For instance, in step 504, FI computing system 130 may perform operations that obtain elements of deployed input data (e.g., deployed input data 244 of FIGS. 2C and 3), which characterize a composition of an input dataset for the trained machine learning or artificial intelligence process (e.g., the adaptively trained, and validated, gradient-boosted, decision-tree process described herein) and identify each of the discrete feature values within the input dataset, along with a sequence or position of these feature values within the input dataset.

By way of example, FI computing system 130 may perform operations, described herein, that obtain or extract one or more of the input features values from corresponding elements of the request data (e.g., from the elements of product data or applicant documentation), and additionally, or alternatively, that obtain or extract additional, or alternative, ones of the input features values from elements of previously ingested customer profile, account, transaction, or credit-bureau data that characterize the applicants involved in the application. Further, in some instances, FI computing system 130 may perform any of the exemplary processes described herein to compute, determine, or derive one or more of the features values based on elements of data extracted or obtained from the corresponding elements of the request data (e.g., from the elements of product data or applicant documentation), and additionally, or alternatively, from the elements of previously ingested customer profile data, account data, transaction data, and credit bureau data associated with the applicants. Further, FI computing system 130 may perform any of the exemplary processes described herein to package each of the obtained, extracted, computed, determined, or derived input feature values into corresponding portions of input dataset in accordance with their respective, sequences or positions specified within the elements of the deployed input data.

Referring back to FIG. 5, FI computing system 130 may perform any of the exemplary processes described herein to apply the trained machine learning or artificial intelligence process (e.g., the adaptively trained, gradient-boosted, decision-tree process,) to the elements of the input dataset (e.g., in step 514 of FIG. 5). For example, in step 506, FI computing system 130 may obtain elements of deployed process data (e.g., deployed process data 242 of FIGS. 2C and 3) that include one or more process parameters of the trained machine learning or artificial intelligence process. As described herein, and for the adaptively trained, gradient-boosted, decision-tree process, the process parameters included within the deployed process data may include, but are not limited to, a learning rate, a number of discrete decision trees included (e.g., the “n_estimator” for the adaptively trained, gradient-boosted, decision-tree process), a tree depth characterizing a depth of each of the discrete decision trees, a minimum number of observations in terminal nodes of the decision trees, and/or values of one or more hyperparameters that reduce potential model overfitting (e.g., regularization of pseudo-regularization hyperparameters).

In some instances, and based on elements of deployed process data, FI computing system 130 may perform any of the exemplary processes described herein to a plurality of nodes and a plurality of decision trees for the adaptively trained machine learning or artificial intelligence process, each of which receive, as inputs (e.g., “ingest”), corresponding elements of the input dataset (e.g., also in step 514 of FIG. 5). Further, and based on the ingestion of the input dataset by the established nodes and decision trees of the adaptively trained, gradient-boosted, decision-tree process, FI computing system 130 may perform any of the exemplary processes described herein that apply the adaptively trained, gradient-boosted, decision-tree process to the input dataset (e.g., also in step 514 of FIG. 5), and that generate (i) elements of output data indicative of the expected final decision on a pre-approval of the application for the home mortgage, the HELOC, or the other RESL product characterized by the elements of request data and (ii) elements of explainability data that characterize a relative importance of one or more of the input feature values included the input dataset (e.g., in step 516 of FIG. 5).

FI computing system 130 may also perform any of the exemplary processes described herein to generate elements of response data that include, among other things, the unique, alphanumeric identifier of the application for the home mortgage, HELOC, or other RESL product characterized by the elements of request data, along with the elements of output data indicative of the expected final decision on a pre-approval of the application (e.g., in step 518 of FIG. 5), and as described herein, FI computing system 130 may transmit the generated elements of response data, including the unique, alphanumeric identifier of the application and the elements of output data, across network 120 to a corresponding one of client device 303A or branch device 303B (e.g., in step 520 of FIG. 5). In some examples, FI computing system 130 may transmit the generated elements of response data to the corresponding one of client device 303A or branch device 303B in real-time and contemporaneously with a generation of the elements of request data by the corresponding one of client device 303A or branch device 303B and a receipt of the elements of request data at FI computing system 130 (such as, but not limited to, within twenty seconds of the generation of the elements of request data by the corresponding one of client device 303A or branch device 303B). Exemplary process 500 is then complete in step 510.

### C. Exemplary Hardware and Software Implementations

Embodiments of the subject matter and the functional operations described in this specification can be implemented in digital electronic circuitry, in tangibly embodied computer software or firmware, in computer hardware, including the structures disclosed in this specification and their structural equivalents, or in combinations. Exemplary embodiments of the subject matter described in this specification, including, but not limited to, application programming interfaces (APIs) 134 and 304, ingestion engine 136, pre-processing engine 140, tokenization engine 156, training engine 202, training input module 208, adaptive training module 228, digital application channels 303, real-time predictive engine 306, process input module 308, tokenization module 332, input inferencing module 334, and post-processing module 342, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

What is claimed is:

1. An apparatus, comprising:
a memory storing instructions;
a communications interface; and
at least one processor coupled to the memory and the communications interface, the at least one processor being configured to execute the instructions to:
receive application data from a device via the communications interface, the application data characterizing an application for an exchange of data involving one or more applicants;
generate an input dataset based on at least a portion of the application data and on interaction data characterizing the one or more applicants, and based on an application of a trained artificial intelligence process to the input dataset, generate, in real-time, elements of output data indicative of a predicted pre-approval of the application for the data exchange involving the one or more applicants; and
transmit the elements of output data to the device via the communications interface, the device being configured to process the elements of output data and present a graphical representation of the predicted pre-approval within a digital interface.

2. The apparatus of claim 1, wherein:
the application data comprises an identifier of each of the one or more applicants; and
the at least one processor is further configured to execute the instructions to:
obtain a portion of the interaction data from the memory based on the identifier of each of the one or more applicants; and
generate the input dataset based on the portion of the application data and on the portion of the interaction data.

3. The apparatus of claim 1, wherein the at least one processor is further configured to execute the instructions to:
obtain (i) one or more process parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more process parameters.

4. The apparatus of claim 3, wherein the at least one processor is further configured to execute the instructions to:
based on the data that characterizes the composition, perform operations that (i) extract a first feature value from at least one of the portion of the application data or the interaction data and that (ii) compute a second feature value based on at least one of the portion of the application data or the interaction data; and
generate the input dataset based on at least one of the extracted first feature value or the computed second feature value.

5. The apparatus of claim 1, wherein:
the application data comprises elements of applicant data that characterize a first applicant and a second applicant; and
the at least one processor is further configured to execute the instructions to:
based on data that characterizes a composition of the input dataset, perform operations that at least one of (i) extract a first feature value from the elements of applicant data or (ii) compute a second feature value based on the elements of applicant data; and
generate the input dataset based on the at least one of the extracted first feature value or the computed second feature value.

6. The apparatus of claim 1, wherein:
the application data comprises a first identifier of a first applicant and a second identifier of a second applicant; and
the at least one processor is further configured to execute the instructions to:
obtain, from the memory, a first portion of the interaction data based on the first identifier, and obtain, from the memory, a second portion of the interaction data based on the second identifier;
based on data that characterizes a composition of the input dataset, compute a feature value based on the first and second portions of the interaction data; and
generate the input dataset based on the computed feature value.

7. The apparatus of claim 1, wherein the trained artificial intelligence process comprises a trained, gradient-boosted, decision-tree process.

8. The apparatus of claim 1, wherein the at least one processor is further configured to execute the instructions to:
obtain elements of additional applicant and interaction data, each of the elements of additional applicant and interaction data comprising a temporal identifier associated with a temporal interval;
based on the temporal identifiers, determine that a first subset of the elements of additional applicant and interaction data are associated with a first prior interval, and that a second subset of the elements of additional applicant and interaction data are associated with a second prior interval;
perform operations that decompose the first subset into a training partition and a validation partition; and
generate a plurality of training datasets based on corresponding ones of the elements of additional applicant and interaction data associated with the training partition, and perform operations that train an additional artificial intelligence process based on the training datasets.

9. The apparatus of claim 8, wherein the at least one processor is further configured to execute the instructions to:
generate a plurality of validation datasets based on corresponding ones of the elements of additional applicant and interaction data associated with the validation partition;
apply the trained additional artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained additional artificial intelligence process.

10. The apparatus of claim 9, wherein the at least one process is further configured to execute the instructions to:
generate a plurality of testing datasets based on corresponding ones of the elements of additional applicant and interaction data associated with the second subset;
apply the validated additional artificial intelligence process to the plurality of testing datasets, and generate further elements of output data based on the application of the validated additional artificial intelligence process to the plurality of testing datasets;
compute one or more testing metrics based on the further elements of output data; and
based on a determined consistency between the one or more testing metrics and the threshold condition, generate (i) one or more process parameters that characterize the validated additional artificial intelligence process and (ii) data that characterizes a composition of a corresponding input dataset for the validated additional artificial intelligence process.

11. The apparatus of claim 1, wherein:
the device is operable by at least one of the one or more applicants, and the application data is generated by an application program executed at the device; and
the at least one processor is further configured to execute the instructions to:
generate response data that include the elements of output data and an application identifier; and
transmit the response data to the device via the communications interface, the response data causing the executed application program to process the application identifier and the elements of output data and to present the graphical representation of the predicted pre-approval within the digital interface.

12. A computer-implemented method, comprising:
receiving application data from a device using at least one processor, the application data characterizing an application for an exchange of data involving one or more applicants;
using the at least one processor, generating an input dataset based on at least a portion of the application data and on interaction data characterizing the one or more applicants, and based on an application of a trained artificial intelligence process to the input dataset, generating, in real-time, elements of output data indicative of a predicted pre-approval of the application for the data exchange involving the one or more applicants; and
transmitting the elements of output data to the device using the at least one processor, the device being configured to process the elements of output data and present a graphical representation of the predicted pre-approval within a digital interface.

13. The computer-implemented method of claim 12, wherein:
the computer-implemented method further comprises obtaining, using the at least one processor, (i) one or more process parameters that characterize the trained artificial intelligence process and (ii) data that characterizes a composition of the input dataset;
the generating comprises generating the input dataset in accordance with the data that characterizes the composition; and
the computer-implemented method further comprises applying, using the at least one processor, the trained artificial intelligence process to the input dataset in accordance with the one or more process parameters.

14. The computer-implemented method of claim 13, wherein:
the computer-implemented method further comprises, based on the data that characterizes the composition, and using the at least one processor, performing operations that (i) extract a first feature value from at least one of the portion of application data or the interaction data and that (ii) compute a second feature value based on at least one of the portion of the application data or the interaction data; and
the generating comprises generating the input dataset based on at least one of the extracted first feature value or the computed second feature value.

15. The computer-implemented method of claim 12, wherein:
the application data comprises elements of applicant data that characterize a first applicant and a second applicant;
the computer-implemented method further comprises, based on data that characterizes a composition of the input dataset, performing operations, using the at least one processor, that at least one of (i) extract a first feature value from the elements of applicant data or (ii) compute a second feature value based on the elements of applicant data; and
the generating comprises generating the input dataset based on the at least one of the extracted first feature value or the computed second feature value.

16. The computer-implemented method of claim 12, wherein:
the application data comprises a first identifier of a first applicant and a second identifier of a second applicant; and
the computer-implemented method further comprises:
obtaining, using the at least one processor, (i) a first portion of the interaction data based on the first identifier and (ii) a second portion of the interaction data based on the second identifier;
based on data that characterizes a composition of the input dataset, computing, using the at least one processor, a feature value based on the first and second portions of the interaction data; and
the generating comprises generating the input dataset based on the computed feature value.

17. The computer-implemented method of claim 12, further comprising:
obtaining, using the at least one processor, elements of additional applicant and interaction data, each of the elements of additional applicant and interaction data comprising a temporal identifier associated with a temporal interval;
based on the temporal identifiers, determining, using the at least one processor, that a first subset of the elements of additional applicant and interaction data are associated with a first prior interval, and that a second subset of the elements of additional applicant and interaction data are associated with a second prior interval;
performing operations, using the at least one processor, that decompose the first subset into a training partition and a validation partition; and
using the at least one processor, generating a plurality of training datasets based on corresponding ones of the elements of additional applicant and interaction data associated with the training partition, and performing operations that train an additional artificial intelligence process based on the training datasets.

18. The computer-implemented method of claim 17, further comprising:
generating, using the at least one processor, a plurality of validation datasets based on corresponding ones of the elements of additional applicant and interaction data associated with the validation partition;
using the at least one processor, applying the trained additional artificial intelligence process to the plurality of validation datasets, and generating additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validating the trained additional artificial intelligence process using the at least one processor.

19. The computer-implemented method of claim 18, further comprising:
generating, using the at least one processor, a plurality of testing datasets based on corresponding ones of the elements of additional applicant and interaction data associated with the second subset;
using the at least one processor, applying the validated additional artificial intelligence process to the plurality of testing datasets, and generating further elements of output data based on the application of the validated additional artificial intelligence process to the plurality of testing datasets;
computing, using the at least one processor, one or more testing metrics based on the further elements of output data; and
based on a determined consistency between the one or more testing metrics and a threshold condition, generating, using the at least one processor, (i) one or more process parameters that characterize the validated additional artificial intelligence process and (ii) data that characterizes a composition of a corresponding input dataset for the validated additional artificial intelligence process.

20. A tangible, non-transitory computer-readable medium storing instructions that, when executed by at least one processor, cause the at least one processor to perform a method, comprising:
receiving application data from a device, the application data characterizing an application for an exchange of data involving one or more applicants;
generating an input dataset based on at least a portion of the application data and on interaction data characterizing the one or more applicants, and based on an application of a trained artificial intelligence process to the input dataset, generating, in real-time, elements of output data indicative of a predicted pre-approval of the application for the data exchange involving the one or more applicants; and
transmitting the elements of output data to the device, the device being configured to process the elements of output data and present a graphical representation of the predicted pre-approval within a digital interface.
